(19) United States
(12) Patent Application Publication
(10) Pub. No.: US 2023/0232298 A1
(43) Pub. Date: Jul. 20, 2023

(54) Reconfiguration Procedure in a Wireless Communication Network

(71) Applicant: Telefonaktiebolaget LM Ericsson (publ), Stockholm (SE)

(72) Inventors: Ali Parichehrehteroujeni, Linköping (SE); Icaro Leonardo Da Silva, Solna (SE); Marco Belleschi, Solna (SE); Henrik Rydén, Stockholm (SE); Luca Lunardi, Genoa (IT); Sofia Ek, Uppsala (SE); Angelo Centonza, Torrenueva Costa, Granada (ES)

(21) Appl. No.: 18/010,544

(22) PCT Filed: Jun. 15, 2021
(86) PCT No.: PCT/SE2021/050580

§ 371 Date: Dec. 15, 2022

Related U.S. Application Data
(60) Provisional application No. 63/039,276, filed on Jun. 15, 2020.

(51) Int. Cl. H04W 36/08; H04W 36/00

(52) U.S. Cl. CPC H04W 36/08; H04W 36/0085

(57) ABSTRACT

A network node (1700) configured to operate as a source network node (32) of a reconfiguration procedure transmits signaling to a target network node (34) of the reconfiguration procedure. The signaling indicates (i) whether or not the target network node (34) is to provide feedback information (44) to the source network node (32) and/or (ii) which one or more types of feedback information (44) the target network node (34) is to provide to the source network node (32). Based on the received feedback information (44), the network node may train a model to predict predicted information, predict the predicted information using the model, and make a decision based on the predicted information.

### TECHNICAL FIELD

The present application relates generally to a wireless communication network, and relates more particularly to a reconfiguration procedure in such a network.

### BACKGROUND

FIG. 1 depicts a 5G radio access network (RAN) architecture, e.g., as described in 3^{rd} Generation Partnership (3GPP) Technical Specification (TS) 38.401v15.4. The 5G RAN is also referred to as the Next Generation (NG) RAN, i.e., NG-RAN. The NG-RAN 10 consists of a set of gNBs 10A, 10B connected to the 5G Core (5GC) 12 through the NG interfac80e. An gNB can support Frequency Division Duplexing (FDD) mode, Time Division Duplexing (TDD) mode or dual mode operation. gNBs can be interconnected through the Xn interface. A gNB may consist of a gNB Central Unit (gNB-CU) 14 and gNB Distribution Units (gNB-DUs) 16. A gNB-CU 14 and a gNB-DU 16 are connected via an F1 logical interface. One gNB-DU 16 is connected to only one gNB-CU 14. For resiliency, a gNB-DU 16 may be connected to multiple gNB-CUs 14 by appropriate implementation. NG, Xn and F1 are logical interfaces. The NG-RAN 10 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signalling transport.

A gNB may also be connected to a Long Term Evolution (LTE) LTE eNB via the X2 interface. In another architectural option, an LTE eNB connected to the Evolved Packet Core (EPC) network is connected over the X2 interface with a so called nr-gNB. The latter is a gNB not connected directly to a core network (CN) and connected via X2 to an eNB for the sole purpose of performing dual connectivity.

The architecture in FIG. 1 can be expanded by spitting the gNB-CU 14 into two entities. One gNB-CU User Plane (UP) (gNB-CU-UP), which serves the user plane and hosts the Packet Data Convergence Protocol (PDCP) protocol and one gNB-CU Control Plane (gNB-CU-CP), which serves the control plane and hosts the PDCP and Radio Resource Control (RRC) protocol. For completeness it should be said that a gNB-DU 16 hosts the RLC/MAC/PHY protocols, where RLC stands for Radio Link Control, MAC stands for Medium Access Control, and PHY stands for Physical.

The handover (HO) preparation procedure is used to establish necessary resources in an LTE eNB or a New Radio (NR) gNB for an incoming handover of a user device from a neighboring network node. FIG. 2 illustrates a successful handover preparation event as described in 3GPP TS 36.423 for LTE and 3GPP TS 38.423 for NR. In this case, the source network node 20, such as a 3GPP eNB node or a 3GPP NR gNB node, initiates the procedure by sending the HANDOVER REQUEST message 24 to the target network node 22 (i.e., a 3GPP eNB node or a 3GPP NR gNB node, respectively). When the source network node 20 sends the HANDOVER REQUEST message 24, it shall start the timer TRELOCprep. In case of a successful handover preparation, the target network node 22 transmits a HANDOVER REQUEST ACKNOWLEDGE message 26 to the source network node 20, as showed in FIG. 2. Otherwise, the target network node 22 transmits a HANDOVER PREPARATION FAILURE message as described, for instance, in Figure 8.2.1.3-1 of the 3GPP TS 36.423 for the LTE standard.

The procedure uses UE-associated signaling, and as such the HANDOVER REQUEST message 24 may comprise a number of user specific information elements (IE) which shall be used by the target network node to serve the user device in case of successful handover preparation. Examples of user specific IEs used for handover preparation include:
Subscriber Profile ID for RAT/Frequency priority IE, if available, where RAT stands for Radio Access Technology;
The Additional RRM Policy Index, where RRM stands for Radio Resource Management;
UE History Information IE: upon receiving such IE, the target network node shall collect the information defined as mandatory in the UE History Information IE and shall, if supported, collect the information defined as optional in the UE History Information IE, for as long as the UE stays in one of its cells, and store the collected information to be used for future handover preparations;
the UE History Information from the UE IE;
the Mobility Information IE;
the Expected UE Behaviour IE;
the UE Context Reference at the SeNB IE
If the Bearer Type IE
Etc.

For a complete list of user specific information elements exchanged between network nodes during a handover preparation event, refer to the 3GPP TS 36.423 and to the 3GPP TS 38.423 technical specifications for 3GPP LTE and 3GPP NR systems, respectively.

Consider now mobility robustness optimization (MRO) in LTE. Seamless handovers are a key feature of 3GPP technologies. Successful handovers ensure that the UE moves around in the coverage area of different cells without causing too much interruption in the data transmission. However, there will be scenarios when the network fails to handover the UE to the ‘correct’ neighbor cell in time and in such scenarios the UE will declare a radio link failure (RLF). The RLF will cause a poor user experience as the RLF is declared by the UE only when it realizes that there is no reliable communication channel (radio link) available between itself and the network. The cause for the radio link failure could be one of the following: (1) Expiry of the radio link monitoring related timer T310; (2) Expiry of the measurement reporting associated timer T312 (not receiving the handover command from the network within this timer's duration despite sending the measurement report when T310 was running); (3) Upon reaching the maximum number of RLC retransmissions; or (4) Upon receiving random access problem indication from the MAC entity.

Upon declaring the RLF, the UE performs the re-establishment procedure. Before the standardization of MRO related report handling in the network, only the UE was aware of some statistics associated to how did the radio quality look like at the time of RLF, what is the actual reason for declaring RLF, etc. For the network to identify the reason for the RLF, the network needs more information, both from the UE and also from the neighboring base stations.

As part of the MRO solution in LTE, the RLF reporting procedure was introduced in the RRC specification in Rel-9 RAN2 work. The contents of the measurement report have been enhanced with more details in the subsequent releases. Some of the measurements included in the measurement report based on the latest LTE RRC specification Error! Reference source not found.are:
1) Measurement quantities (RSRP, RSRQ) of the last serving cell (PCell), where RSRP stands for Reference Signal Received Power and RSRQ stands for Reference Signal Received Quality.
2) Measurement quantities of the neighbor cells in different frequencies of different RATs (EUTRA, UTRA, GERAN, CDMA2000).
3) Measurement quantity (RSSI) associated to Wireless Local Area Network (WLAN) Access Points (APs).
4) Measurement quantity (Reference Signal Strength Indicator, RSSI) associated to Bluetooth beacons.
5) Location information, if available (including location coordinates and velocity)
6) Globally unique identity of the last serving cell, if available, otherwise the Physical Cell Identity (PCI) and the carrier frequency of the last serving cell.
7) Global unique identity or PCI and carrier frequency of cell where failure occurred (e.g. handover target cell in the case of a too early HO)
8) Time elapsed since the failure occurred
9) Tracking area code of the PCell.
10) Time elapsed since the last reception of the ‘Handover command’ message.
11) Cell Radio Network Temporary Identity (C-RNTI) used in the previous serving cell.
12) Whether or not the UE was configured with a Data Radio Bearer (DRB) having Quality of Service (QoS) Class Identifier (QCI) value of 1.
13) type of connection failure (too late handover, too early HO)
14) RLF failure cause (e.g. T310 expiration, random access problems

These measurements are typically reported to the cell in which the UE performs reestablishment via UEInformationRequest and UEInformationResponse related framework.

Based on the contents of the RLF report (especially the Globally unique identity of the last serving cell), the cell in which the UE reestablishes can forward the RLF report to the last serving cell. This forwarding of the RLF report is done to aid the original serving cell with tuning of the handover related parameters, as the original serving cell was the one who had configured the parameters associated to the UE that led to the RLF.

Two different types of inter-node MRO messages have been standardized in LTE, namely: (i) Radio link failure indication; and (ii) handover report.

The radio link failure indication procedure is used to transfer information regarding RRC re-establishment attempts or received RLF reports between eNBs. This message is sent from the eNB in which the UE performs reestablishment to the eNB which was the previous serving cell of the UE. In particular, the message is sent by the eNB₂ to indicate an RRC re-establishment attempt or a reception of an RLF Report from a UE that suffered a connection failure at eNB₁.

Based on the RLF report from the UE and the knowledge of in which cell the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as belonging to either a too-early class, a too-late class, or a handover to wrong cell class. These handover failure classes are explained in brief below.

Consider first whether the handover failure occurred due to the ‘too-late handover’. The original serving cell can classify a handover failure to be ‘too late handover’ when the original serving cell fails to send the handover command to the UE associated to a handover towards a particular target cell and if the UE reestablishes itself in this target cell post RLF. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.

Consider next whether the handover failure occurred due to the ‘too-early handover’. The original serving cell can classify a handover failure to be ‘too early handover’ when the original serving cell is successful in sending the handover command to the UE associated to a handover however the UE fails to perform the random access towards this target cell. An example corrective action from the original serving cell could be to initiate the handover procedure towards this target cell a bit later by increasing the CIO (cell individual offset) towards the target cell that controls when the IE sends the event triggered measurement report that leads to taking the handover decision.

Consider finally whether the handover failure occurred due to the ‘handover-to-wrong-cell’ case. The original serving cell can classify a handover failure to be ‘handover-to-wrong-cell’ when the original serving cell intends to perform the handover for this UE towards a particular target cell but the UE declares the RLF and reestablishes itself in a third cell. A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

Consider now a handover report. To aid the serving cell to classify a handover as ‘too-late’ handover, the RLF reporting from the reestablishment cell to the original source cell is enough. To classify a handover as ‘too early’ or ‘handover to wrong cell’, the serving cell may further benefit from a ‘handover report’ message. This message is sent by the eNB₁ to report a handover failure event or other critical mobility problem. The handover report message indicates the handover report type as being ‘HO too early’, “HO to wrong cell”, . . . ‘InterRAT ping-pong’. The handover report message also indicates the handover cause employed for handover from eNB₂, as well as mobility information provided in the handover request message from eNB₂.

There currently exist certain challenge(s). In a typical implementation of NR handover procedure, like LTE, the handover is based on the measurement reports sent by the UE (e.g. measurement reports based on A3 events for intra-frequency handovers). In fact, a target cell can be selected by a serving node based on the radio measurements provided by the UEs (e.g. RSRP, RSRQ, SINR, where SINR stands for signal-to-interference-plus-noise-ratio). The serving node sends a request to the target node which may confirm the handover request after admission control.

However, a need remains for improving handover and other types of reconfiguration procedures. Indeed, measurement reports at cell boundaries, and even RLF reports, may be insufficient for optimizing reconfiguration procedures under some circumstances.

### SUMMARY

Some embodiments herein recognize that measurement reports at cell boundaries may not give a complete picture of the quality of service that a user equipment (UE) would experience at a target cell after a handover (HO) is executed to that target cell. For example, there might be some cases where a target cell may be observed/measured with good cell coverage at cell boundaries but may provide a poor quality of service (e.g. poor throughput) after HO. The situation might be different for other cells—being measured with low (not the best) coverage at cell boundaries while having a good quality of service (e.g. throughput) after HO.

In addition, considering the diversity of services provided to the UEs in NR technology, a UE's quality of service requirements may suddenly change upon switching between the running services. For example, a UE running Voice over Internet Protocol (VOIP)/Ultra Reliable Low Latency Communication (URLLC) service may switch to enhanced Mobile BroadBand (eMBB)-like services so as to drastically change the UE requirements to ones that may not be enabled/provisioned by the selected target cell.

Heretofore, after a handover to a target cell, the source/serving node would act obliviously about the handed over UE, i.e. would not be interested in that UE any longer. Therefore, if the UE experiences low throughput or poor radio coverage (or even a radio link failure), the source node of the handover would heretofore not be able to recognize and take any counteraction preventing such handovers causing poor performance for the UEs.

A need remains, therefore, for solving these and other challenges, especially in a way that proves efficient from a signaling overhead perspective.

Generally, some embodiments herein advantageously provide configurability as to whether a target network node provides feedback information to a source network node and/or as to which type(s) of feedback information the target network node provides to the source network node. The feedback information may for instance be collected during and/or after a reconfiguration procedure to the target network node, or otherwise include information that is usable to predict future performance of a reconfiguration procedure (e.g., a handover procedure) to the target network node. In any event, such configurability may be performed on a dynamic or semi-static basis, so that the configuration may adapt over time. Alternatively or additionally, such configurability may be performed on a target network node by target network node basis so that configurability may be tailored to each target network node individually. Regardless, rather than each target network node being statically and/or blindly required to provide certain feedback information to the source network node, the source network node may configure a target network node to provide only select feedback information, e.g., only feedback information that will actually be used by the source network node. This may advantageously reduce feedback signaling overhead, as well as conserve transmission resources and network node processing resources.

More particularly, embodiments herein include a method performed by a network node configured to operate as a source network node of a reconfiguration procedure. The method comprises transmitting, to a target network node of the reconfiguration procedure, signaling that indicates (i) whether or not the target network node is to provide feedback information to the source network node; and/or (ii) which one or more types of feedback information the target network node is to provide to the source network node.

In some embodiments, the feedback information includes at least one of any one or more of the following types of feedback information: information about the reconfiguration procedure, information about a wireless device that performs the reconfiguration procedure, information about the target network node or a target cell during or after the reconfiguration procedure, one or more measurements performed by the target network node during and/or after the reconfiguration procedure, and one or more measurements performed by the wireless device during and/or after the reconfiguration procedure.

In some embodiments, the feedback information includes information about a configuration adopted for a wireless device after the wireless device performs the reconfiguration procedure. In one or more of these embodiments, the information about the configuration adopted for the wireless device includes information about at least one of any one or more of: a dual connectivity configuration adopted for the wireless device after the wireless device performs the reconfiguration procedure, a carrier aggregation configuration adopted for the wireless device after the wireless device performs the reconfiguration procedure, and a feature set and/or band combination adopted for the wireless device after the wireless device performs the reconfiguration procedure.

In some embodiments, the feedback information includes information about a configuration at the target network node during and/or after the reconfiguration procedure. In one or more of these embodiments, the information about the configuration at the target network node during and/or after the reconfiguration procedure includes information about at least one of any one or more of: overall capacity utilized by a wireless device at the target network node, overall percentage of physical resource blocks used by a wireless device at a target cell of the reconfiguration procedure, and overall throughput achieved via a configuration applied at a wireless device after the wireless device performs the reconfiguration procedure.

In some embodiments, the signaling indicates a time window within which the feedback information is requested from the target network node after execution of the reconfiguration procedure.

In some embodiments, the signaling indicates a criterion that is to trigger the target network node to transmit a type of feedback information to the source network node. In this case, the criterion is that a value of the type of feedback information is below a threshold, is above a threshold, is outside of a range, or is inside of a range, and the signaling indicates the threshold or the range.

In some embodiments, the method further comprises receiving the feedback information indicated by the signaling. In one or more of these embodiments, the method further comprises training, based on the received feedback information, a model to predict predicted information, predicting the predicted information using the model, and making a decision based on the predicted information. In one or more of these embodiments, the decision is a decision about whether a wireless device is to perform a reconfiguration procedure to the target network node, which wireless device is to perform a reconfiguration procedure to the target network node, or which network node is to be a target of a reconfiguration procedure to be performed by a wireless device.

In some embodiments, the reconfiguration procedure is a mobility procedure, a Primary Secondary Cell (PSCell) addition or change procedure, or a conditional reconfiguration procedure.

Other embodiments herein include a performed by a network node configured to operate as a target network node of a reconfiguration procedure. The method comprises receiving, from a source network node of the reconfiguration procedure, signaling that indicates (i) whether or not the target network node is to provide feedback information to the source network node; and/or (ii) which one or more types of feedback information the target network node is to provide to the source network node.

In some embodiments, the feedback information includes at least one of any one or more of the following types of feedback information: information about the reconfiguration procedure, information about a wireless device that performs the reconfiguration procedure, information about the target network node or a target cell during or after the reconfiguration procedure, one or more measurements performed by the target network node during and/or after the reconfiguration procedure, and one or more measurements performed by the wireless device during and/or after the reconfiguration procedure.

In some embodiments, the feedback information includes information about a configuration adopted for a wireless device after the wireless device performs the reconfiguration procedure. In one or more of these embodiments, the information about the configuration adopted for the wireless device includes information about at least one of any one or more of: a dual connectivity configuration adopted for the wireless device after the wireless device performs the reconfiguration procedure, a carrier aggregation configuration adopted for the wireless device after the wireless device performs the reconfiguration procedure, and a feature set and/or band combination adopted for the wireless device after the wireless device performs the reconfiguration procedure.

In some embodiments, the feedback information includes information about a configuration at the target network node during and/or after the reconfiguration procedure. In one or more of these embodiments, the information about the configuration at the target network node during and/or after the reconfiguration procedure includes information about at least one of any one or more of: overall capacity utilized by a wireless device at the target network node, overall percentage of physical resource blocks used by a wireless device at a target cell of the reconfiguration procedure, and overall throughput achieved via a configuration applied at a wireless device after the wireless device performs the reconfiguration procedure.

In some embodiments, wherein the signaling indicates a time window within which the feedback information is requested from the target network node after execution of the reconfiguration procedure.

In some embodiments, the signaling indicates a criterion that is to trigger the target network node to transmit a type of feedback information to the source network node. In this case, the criterion is that a value of the type of feedback information is below a threshold, is above a threshold, is outside of a range, or is inside of a range, and the signaling indicates the threshold or the range.

In some embodiments, the method further comprises deciding, based on the received signaling, whether to transmit feedback information to the source network node. Additionally or alternatively, the method further comprises deciding, based on the received signaling, which one or more types of feedback information to transmit to the source network node.

In some embodiments, the method further comprises transmitting, to the source network node, the feedback information indicated by the signaling.

In some embodiments, the reconfiguration procedure is a mobility procedure, a PSCell addition or change procedure, or a conditional reconfiguration procedure.

Other embodiments herein include a network node configured to operate as a source network node of a reconfiguration procedure. The network node is configured to transmit, to a target network node of the reconfiguration procedure, signaling that indicates whether or not the target network node is to provide feedback information to the source network node. Additionally or alternatively, the network node is configured to transmit, to a target network node of the reconfiguration procedure, signaling that indicates which one or more types of feedback information the target network node is to provide to the source network node.

In some embodiments, the network node is configured to perform the steps described above for a network node.

Other embodiments herein include a network node configured to operate as a target network node of a reconfiguration procedure. The network node is configured to receive, from a source network node of the reconfiguration procedure, signaling that indicates whether or not the target network node is to provide feedback information to the source network node. Additionally or alternatively, the network node is configured to receive, from a source network node of the reconfiguration procedure, signaling that indicates which one or more types of feedback information the target network node is to provide to the source network node.

In some embodiments, the network node is configured to perform the steps described above for a network node.

Other embodiments herein include a computer program comprising instructions which, when executed by at least one processor of a network node, causes the network node to perform the steps described above for a network node. In some embodiments, a carrier containing the computer program is one of an electronic signal, optical signal, radio signal, or computer readable storage medium.

Other embodiments herein include a network node configured to operate as a source network node of a reconfiguration procedure. The network node comprises communication circuitry and processing circuitry. The processing circuitry is configured to transmit, to a target network node of the reconfiguration procedure, signaling that indicates whether or not the target network node is to provide feedback information to the source network node. Additionally or alternatively, the processing circuitry is configured to transmit, to a target network node of the reconfiguration procedure, signaling that indicates which one or more types of feedback information the target network node is to provide to the source network node.

In some embodiments, the processing circuitry is configured to perform the steps described above for a network node.

Other embodiments herein include a network node configured to operate as a target network node of a reconfiguration procedure. The network node comprises communication circuitry and processing circuitry. The processing circuitry is configured to receive, from a source network node of the reconfiguration procedure, signaling that indicates whether or not the target network node is to provide feedback information to the source network node. Additionally or alternatively, the processing circuitry is configured to receive, from a source network node of the reconfiguration procedure, signaling that indicates which one or more types of feedback information the target network node is to provide to the source network node.

In some embodiments, the processing circuitry is configured to perform the steps described above for a network node.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a 5G network.

FIG. 2 is a call flow diagram of a successful handover procedure.

FIG. 3 is a call flow diagram of feedback from a target node to a source node of a mobility procedure according to some embodiments.

FIG. 4 is a logic flow diagram of a method performed by a source node according to some embodiments.

FIG. 5 is a logic flow diagram of a method performed by a target node according to some embodiments.

FIG. 6 is a call flow diagram of feedback from a target node to a source node of a mobility procedure according to other embodiments.

FIG. 7 is a logic flow diagram of a method performed by a source node according to other embodiments.

FIG. 8 is a logic flow diagram of a method performed by a target node according to other embodiments.

FIGS. 9a-9c are block diagrams of machine learning according to some embodiments.

FIG. 10 is a call flow diagram of signaling for configuring feedback from a target node to a source node of a mobility procedure according to some embodiments.

FIG. 11 is a block diagram of mobility history information according to some embodiments.

FIG. 12 is a block diagram of mobility history information reporting to AMF/OAM according to some embodiments.

FIG. 13 is a logic flow diagram of a method performed by a wireless device according to some embodiments.

FIG. 14 is a logic flow diagram of a method performed by a network node configured to operate as a source network node of a reconfiguration procedure according to some embodiments.

FIG. 15 is a logic flow diagram of a method performed by a network node configured to operate as a target network node of a reconfiguration procedure according to some embodiments.

FIG. 16 is a block diagram of a wireless device according to some embodiments.

FIG. 17 is a block diagram of a network node according to some embodiments.

FIG. 18 is a block diagram of a wireless communication network according to some embodiments.

FIG. 19 is a block diagram of a user equipment according to some embodiments.

FIG. 20 is a block diagram of a virtualization environment according to some embodiments.

FIG. 21 is a block diagram of a communication network with a host computer according to some embodiments.

FIG. 22 is a block diagram of a host computer according to some embodiments.

FIG. 23 is a flowchart illustrating a method implemented in a communication system, in accordance with one embodiment.

FIG. 24 is a flowchart illustrating a method implemented in a communication system, in accordance with one embodiment.

FIG. 25 is a flowchart illustrating a method implemented in a communication system, in accordance with one embodiment.

FIG. 26 is a flowchart illustrating a method implemented in a communication system, in accordance with one embodiment.

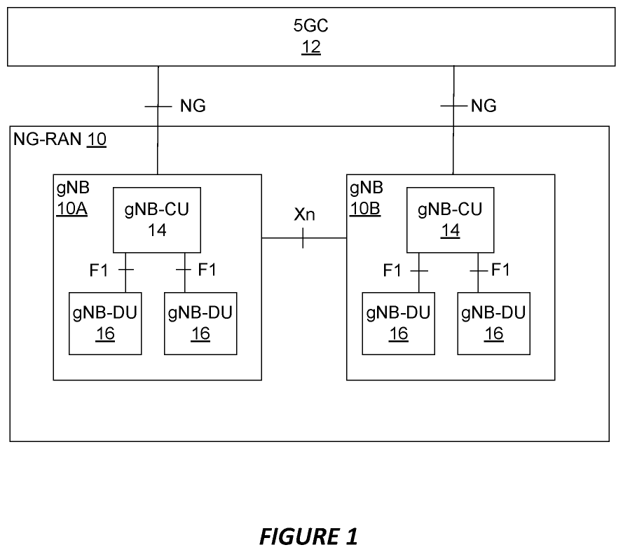

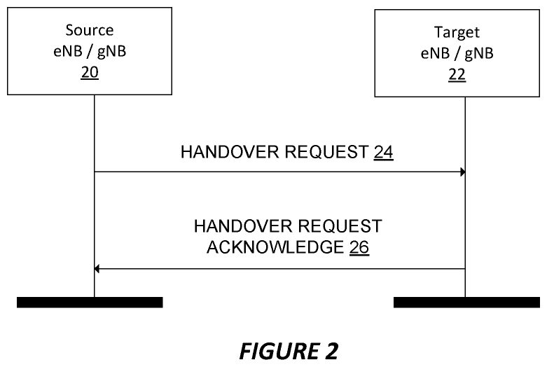

### DETAILED DESCRIPTION

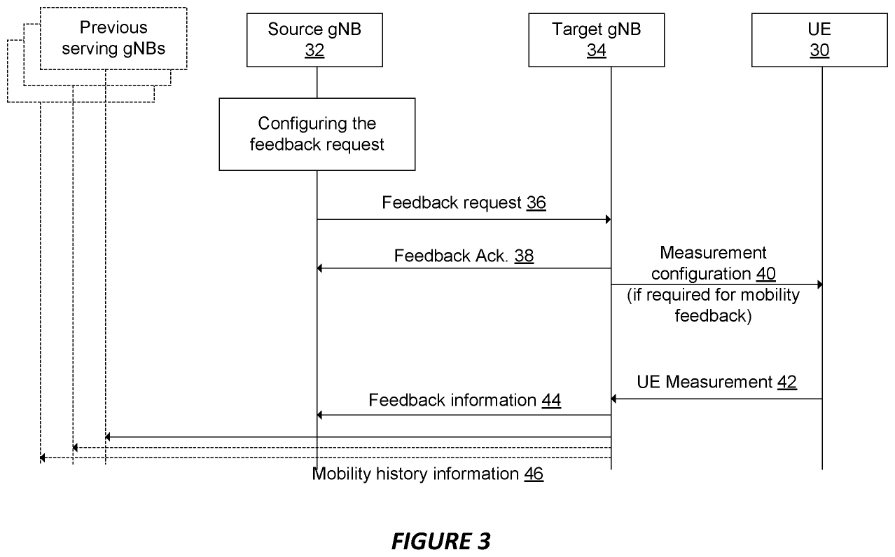

Some embodiments herein enable a feedback mechanism after handover of a user equipment (UE) from a source node to a target node in a wireless communication network, so that the target node provides the source node with measurements related to the UE. FIG. 3 shows one example in the context of a mobility procedure for mobility of a UE 30 from a source node 32 (shown as a source gNB) to a target node 34 (shown as a target gNB).

As shown, the source node 32 configures a feedback request 36 and transmits the feedback request 36 to the target node 34. The feedback request 36 indicates that the source node 32 wants feedback associated to one or more target cells provided by the target node 34. In some embodiments, the target node 34 responds with a feedback acknowledgement (ack.) 38 indicating whether or not the target node 34 will provide the requested feedback to the source node 32.

If the target node 34 will provide the requested feedback, the target node 34 may correspondingly transmit a measurement configuration 40 to a UE 30 served by one of the one or more target cells (if required for providing the requested feedback). The measurement configuration 40 may configure the UE 30 to perform a measurement that is to be included in the feedback or that is to be used for generating the feedback. Thereafter, the target node 34 may correspondingly receive the measurement 42 from the UE 30.

Regardless, target node 34 may transmit the requested feedback 44 to the source node 32. Such feedback 44 may include mobility history information 46.

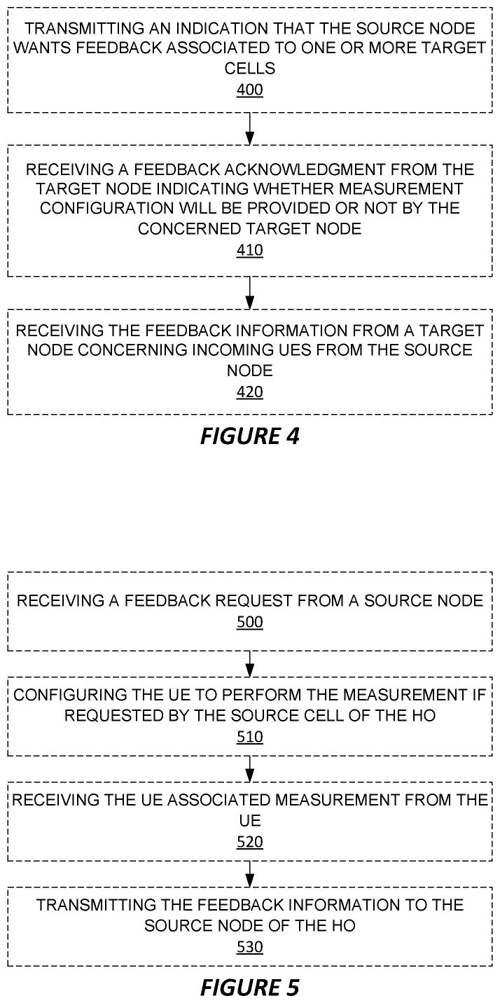

Generally, then, some embodiments comprise a method performed by a source node 32, as shown in FIG. 4. The method comprising one or more of the following steps. The method may comprise transmitting an indication 36 that the source node 32 wants feedback associated 44 to one or more target cells (e.g. after the handover of a UE 3000 from source to target, or during the handover, for example in the Handover Request message) (Block 400). The method may alternatively or additionally comprise receiving a feedback acknowledgment 38 from the target node 34 indicating whether measurement configuration will be provided or not by the concerned target node 34 (Block 410). The feedback acknowledgment 38 may be conveyed into a feedback message sent after handover completion (e.g. in UE context release message), or in the handover acknowledge message.

In some embodiments, the method alternatively or additionally comprises receiving the feedback information 44 from a target node 34 concerning incoming UEs from the source node 32 (Block 420). For example, this can be received after a successful handover from source to target node 34, e.g. upon or after the source receives the UE Context Release message, or as part of the Handover Request acknowledge message.

Alternatively or additionally, some embodiments comprise a method performed by a target node 34, as shown in FIG. 5. The method comprises one or more of the following steps. The method may comprise receiving the feedback request 36 from a source node 32 (Block 500).

In some embodiments, the method further comprises configuring the UE 30 to perform the measurement if requested by the source cell of the HO (Block 510). The method in this case may further comprise receiving the UE associated measurement 42 from the UE 30 (Block 520).

In one or more embodiments, the method also comprises transmitting the feedback information 44 to the source node 32 of the HO (Block 530). The feedback information may include the mobility history information 46.

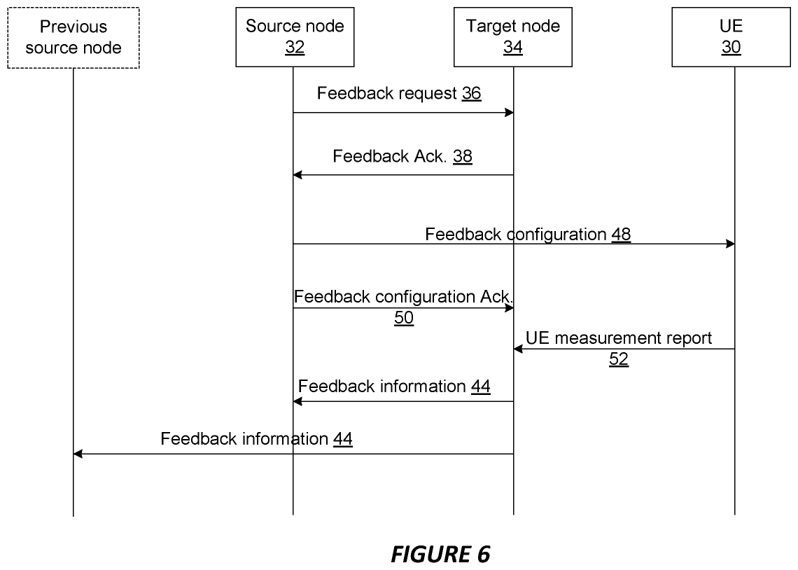

FIG. 6 depicts yet other embodiments herein. As shown, rather than the target node 34 sending the measurement configuration 40 to the UE 30, the source node 32 sends a feedback configuration 48 to the UE 30 directly. The source node 32 may correspondingly send a feedback configuration acknowledgement (ack.) 50 to the target node 34. After the UE 30 sends the UE measurement report 52 to the target node 34 in accordance with the feedback configuration 48, the target node 34 may similarly transmit the feedback information 44 to the source node 32 as described above. Also in this embodiment, the target node 34 may transmit the feedback information 44 to a previous source node as well.

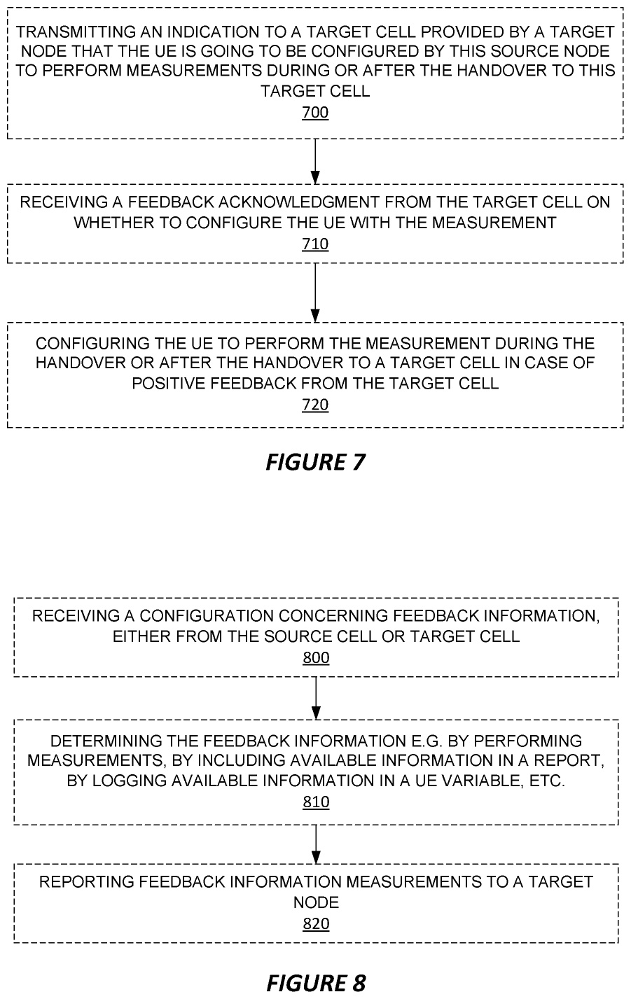

Generally, then, some embodiments include a method performed by a source node 32, shown in FIG. 7. The method comprises one or more of the following steps. The method may comprise transmitting an indication 36 to a target cell provided by a target node 34 that the UE 30 is going to be configured by this source node 32 to perform measurements during or after the handover to this target cell (e.g. after HO completion at reception of UE context release from the concerned target cell, or in the handover request message) (Block 700).

The method may comprise receiving a feedback acknowledgment 38 from the target cell on whether to configure the UE 30 with the measurement (e.g. in a feedback message after handover completion, or in the handover acknowledge message) (Block 710).

The method may comprise configuring the UE 30 (e.g., via feedback configuration 48) to perform the measurement during the handover or after the handover to a target cell in case of positive feedback from the target cell (Block 720). In yet another alternative, such step could also be performed without transmitting any indication to the target cell as in the first step, i.e. irrespective of the feedback form the target cell.

Optionally, a feedback configuration acknowledgment 50 may be sent to the target node 34, once the UE 30 has been configured for measurement report. For example, this message 50 might be needed in case no feedback request 36 was sent to the target node 34 before the configuration 48.

Some embodiments correspondingly comprise a method performed by a wireless terminal 30 (also called User Equipment—UE), as shown in FIG. 8. The method comprises one or more of the following steps. The method comprises receiving a configuration 40, 48 concerning feedback information, either from the source cell or target cell (Block 800). The method may also comprise determining the feedback information, e.g. by performing measurements, by including available information in a report, by logging available information in a UE variable, etc. (Block 810). Finally, the method may include reporting feedback information measurements 42, 52 to a target node 34 (Block 820).

In this context, consider now additional details regarding actions taken by the RAN node owning the source cell of the handover according to some embodiments.

### Mobility Feedback Request Configuration

The methods above describe the reporting of feedback information 44 from a target node 34 to source node 32 concerning at least one UE 30 that performed a handover (more generically, a reconfiguration with sync) from the source node 32 to the target node 34.

The feedback information 44 may comprise information that is derived by a UE 30, also referred to generically as a wireless terminal or wireless device.

The term feedback information 44 may correspond to UE-collected measurements and/or network-internal measurements.

With regard to UE-collected measurements, in some embodiments, feedback information 44 may be obtained from a UE 30. At least one of the following types of UE-collected measurements can be obtained in this regard.

One type of UE-collected measurements may be radio link measurement of cells, in some given frequencies (intra or inter frequency measurements). The configuration of the measurement may be periodic or event based. The time period of the measurement may be the time period after the HO that the UE is requested to perform. The measurement of the neighbouring cells may include cell-level and/or beam-level measurements of a Synchronization Signal Block (SSB) or Channel State Information Reference Signal (CSI-RS) beams. Such measurements may be defined in terms of a beam index/identifier of the measurement beam and/or measurement results such as RSRP, RSRQ, SINR, etc.

The cells for which the UE 30 collects measurements can be the source cell the UE 30 is leaving (i.e. where the UE was connected when the UE received the Handover command—RRCReconfiguration with reconfiguration with sync), the target cell the UE 30 is entering, at least one neighbour cell in a source cell frequency, and/or at least one neighbour cell in a target frequency (frequency of source and target could be the same or different).

In some cases, equivalent information may have been received in a measurement report from the UE 30 to the source. However this may be considered as an update for the conditions after the handover. This may be important in the case of conditional reconfigurations (e.g. CHO, Conditional PSCell addition, Conditional PScell Change) where the measurement reports are transmitted in TO but the execution may occur much later in time so the source node would benefit a lot in knowing the conditions when the UE 30 actually executes the Conditional Reconfiguration(s).

Another type of UE-collected measurements includes any potential radio link failure related information (e.g., RLF report, HO report). This includes pre-RLF measurements (i.e. premortem measurement) and/or post-RLF measurement (i.e. postmortem measurement).

In the case of conditional handover (CHO), for example, the UE 30 may perform CHO execution when it experiences radio link failure (RLF). In other words, despite this being considered by a target node 34 as a successful handover (or CHO execution), the UE 30 might have experienced RLF and might have an RLF report available. Then, upon providing that to the target node 34, the target node 34 may provide this as feedback information 44 to the source node 32.

This may include RLF related information (e.g. state of RLF variables) before the handover is executed. For example, when the UE 30 starts HO execution, timer T304 is started and timer T310 stops, if running. One information the UE 30 may log is the status of timer T310 when it receives the HO command (i.e. the RRCReconfiguration with reconfiguration with sync), e.g. if it is running, what the value is, etc. Other information could be the status of N310 counter and/or N311 counter, and/or number of RACH attempts, etc.

Yet another type of UE-collected measurement includes a successful handover report. A successful handover report may for example include a performance measurement during the HO execution phase. The performance measurement may for instance include Timer T304 value, Timer T310 value, Timer T312 value, a number of RLC retransmission (if greater than zero), a measurement of the beams in which a Random Access Channel (RACH) transmission is performed, a measurement of the beams in which RACH transmission is not performed, an indication of the beams with measurement above the suitability threshold but not selected for RACH as part of HO, measurements of the beams belonging to the source cell configured for RLM purpose (before handover), measurement of the beams belonging to the target cell configured for RLM purpose (after handover), service interruption time, e.g. voice jitter, and/or packet error rate.

Still another type of UE-collected measurement may include UE throughput in Uplink/Downlink (e.g., in terms of an average, mean, median, maximum or instantaneous throughput in uplink or downlink), UE traffic pattern after HO, and/or different types of services running by UE e.g., eMBB, VOIP, URLLV, online gaming, etc.

Alternatively or additionally, UE-collected measurements may include end-to-end (E2E) round trip time (RTT) of the data packets, a packet jitter value in case a UE 30 runs VOIP services over LTE or NR, and/or location information of the UE 30.

With regard to network-internal measurements, the feedback information 44 may be derived by the network e.g. target network node 34. Feedback information 44 in this case may comprise at least one of the following types of network-internal measurements. One type of network-internal measurements includes a dwelling time of the UE 30 inside the target cell after HO. In one embodiment, for example, dwelling time may be classified as dwelling time per RRC_IDLE, RRC_Inactive and RRC_Connected modes.

Another type of network-internal measurement includes UE throughput in Uplink or Downlink (e.g., in terms of an average, mean, median, maximum or instantaneous throughput in uplink or downlink), UE traffic pattern after HO, different types of services running by UE e.g., eMBB, VOIP, URLLV, online gaming, etc., and/or different types of radio bearers used to serve the UE for different services. The UE traffic pattern may be sent in a form of a distribution function or a time series.

Other types of network-internal measurements includes resource utilizations used by the UE 30, experienced latency (e.g., E2E RTT), reliability, any change in a UE's quality of service (QoS) requirements, and/or target cell information after handover (target of the target cell) including for instance PCI, Tracking Area Code (TAC), Public Land Mobile Network (PLMN) identity (ID), etc.

Consider now mobility feedback configuration types according to some embodiments. In one embodiment, the source node 32 may select to request for feedback for a specific UE 30. In another embodiment, the source node 32 may request feedbacks for N number of UEs 30 that are to or have performed HO from the source cell to the target cell.

In yet another embodiment, the source node 32 may set a time period for the UE 30 to report the feedback information measurements. This time can be an absolute time in the future, or the time can be configured as an offset, relative to the current time. The timer period may be represented by the time period in which one UE is connected to one or more cells, or the UE is connected to one or more cells belonging to a certain area. The RAN node owning the source cell may for example select one or more nodes for which there exists a neighbouring cell relationship with this source cell, and indicate a list of cells (e.g. Cell Global Identity—CGI—list or PCI list), or the area ID to which such cells belong to, and for which a measurement report and related feedback information 44 is requested.

In yet another embodiment, the UE 30 may trigger the feedback when a certain event (which may or may not be configured by the source cell) occurs. For example, a feedback triggering event may be a handover event from target to another cell (i.e., when UE leaves the target cell). Alternatively or additionally, a feedback triggering event may be a measurement report received from the UE 30, a feedback triggering even may be an event of receiving a successful handover report from the UE 30, and/or a feedback triggering event may be a successful reestablishment, e.g. upon RLF occurring in the target cell, or in the source cell, or in any other cell having a neighbouring relationship with the source cell.

In another embodiment, the target node 34 may feed back an indication that possible alternative targets exist that might not have been considered due to reduced capability of other potential candidates. For example, due to energy saving related procedures putting cells in sleep mode, the UE 30 might have experienced a reduction e.g. in the available frequencies, bandwidth, number of Multiple Input Multiple Output (MIMO) layers, that made the potential candidates look not favorable for mobility. As another example, other potential candidates may not have been considered due to (temporary) target node overload, e.g. when the requested service attributes (e.g. voice service) are compatible with an alternative RAT.

The source node 32 may use the received indication together with other UE and network attributes (such as preferred frequencies according to operator strategies, allowed number of carriers, supported bandwidth, QoS attributes) to: (i) trigger a request towards the target node 34 to increase the capabilities of the cells under its control, such as wake-up the sleeping cell, increase the number of MIMO layers; and/or (ii) trigger mobility towards a different RAT other than NR to offload NR for those users that could be served nicely e.g. from E-UTRAN.

In another embodiment, the source node 32 may request feedback from the target node 34 comprising the configuration adopted for the UE 30 after the HO was executed. Such configuration may comprise the following examples: (i) Dual Connectivity configuration, for example the cells used for dual connectivity towards the UE 30, the carriers of each such cell, etc.; (ii) Carrier Aggregation configuration, for example the cells used for CA configurations, the carriers of each such cell, etc. (iii) Selection of feature set and/or band combinations; and/or (iv) Configurations applied at the UE 30 for improvement of coverage and capacity.

Together with this information on the configuration at the target node 34, the target node 34 may provide feedback information 44 such as: (i) overall capacity utilized by the UE 30 at target node 34 (this capacity could include the aggregation of capacity used in dual connectivity between master and secondary cell); (ii) overall percentage of Physical Resource Blocks (PRBs) used by the UE 30 at the target cell (this capacity could include the aggregation of PRB utilisation in dual connectivity between master and secondary cell); and/or (iii) overall throughput achieved via the configuration applied at the UE 30.

With this feedback information 44, the source node 32 may become aware of information otherwise heretofore not visible to it. Namely, the source node 32 may become aware of the real capacity and QoS available at the UE 30 in the target cell. Such capacity is not visible at the source node 32 because the current telecommunication standards foresee that the target node 34 signals only the capacity available at its served cells and not the overall capacity and QoS available at the UE 30 in case specific configurations are applied to such UE 30.

The target node 34 may also provide measurements collected by the UE 30 on the cells involved in the configuration applied by the target node 34 to the UE 30. That is, the source node 32 may receive master and secondary cell measurements. This may indicate to the source node 32 information about potential secondary nodes to setup for DC while the UE 30 is still connected at the serving cell.

It is worth noting that a timer can be configured from the source node 32 to the target node 34 for signaling the time window within which the information is requested from the target node 34 after the HO execution.

Consider now artificial intelligence/machine learning (ML) aspects when selecting the feedback request 36. Machine learning (ML) can be used to find a predictive function for a given dataset; the dataset is typically a mapping between a given input to an output. The predictive function (or mapping function) is generated in a training phase, where the training phase assumes knowledge of both the input and output. The execution phase comprises predicting the output for a given input.

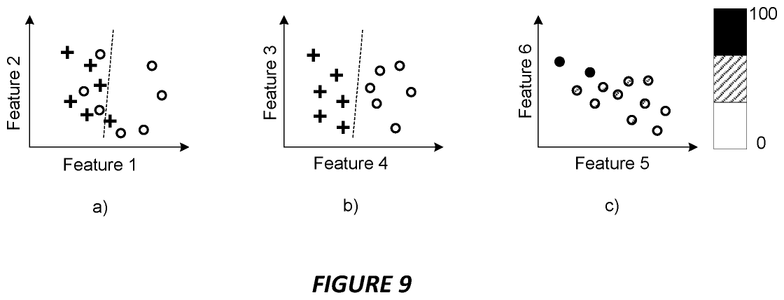

FIG. 9 shows an example of one type of machine learning, namely classification in figure a and b, where the task is to train a predictive function that separates the two classes (circle and cross class). In FIG. 9a, feature 1 and 2 provides low separation of the output class, hence leading to a worse prediction performance in comparison with FIG. 9b, where using feature 3 and 4 enables a better separation and classifying performance. FIG. 9c shows another type of ML problem, namely regression, where the task is to train a predictive function that predicts a value (continuous value between 0-100 in this example) based on its input features. In general, the performance of the machine learner is proportional to the correlation between the input and the output. Key problems in machine learning relate to finding/creating good features and collecting enough data samples. Another problem related to ML in wireless networks is when features and class labels are located at different network nodes, for example at different gNBs.

Some embodiments in this regard aim at improving network operations by introducing new signaling between network nodes. As mentioned, one problem with ML is that some features/output values might not be located at the training entity, but need to be signaled via e.g. XN. The additional signaling between network nodes are associated with a signaling cost and should be kept as low as possible. This relates to the signaling between the source node 32 and target node 34 for example.

Consider now aspects related to training a ML model. In one embodiment, the feedback request 36 to the target node 34 also includes a list of feature information that resides on the target node 34, which can be used to improve the prediction of one or more values related to the feedback information 44 element. The feature information list can be updated based on the experienced correlations between one or more elements in the feedback information 44.

The feature information 44 could comprise target node load information. The target node load information may include, for example, PRB utilization (for last x seconds), the number of connected users (for last x seconds), and/or the number of bearers and bearer type.

In some embodiments, the features at the source node 32 and the features received from the target node 34 are used to build a model used to predict one or more elements in the feedback information 44.

Consider now aspects related to executing the model. Similarly to the training step, the features located at the target nodes need to be signalled to the source node 32 in the execution phase. However, the output values (elements in the feedback information 44) are predicted which can limit the signaling needs of the target cell. The feedback request 36 can in the execution phase indicate that it does not need any feedback information 44. This can depend on the ML model prediction performance of the data received in the training phase, or based on the prediction uncertainty of the model given the input features related to the current UE 30.

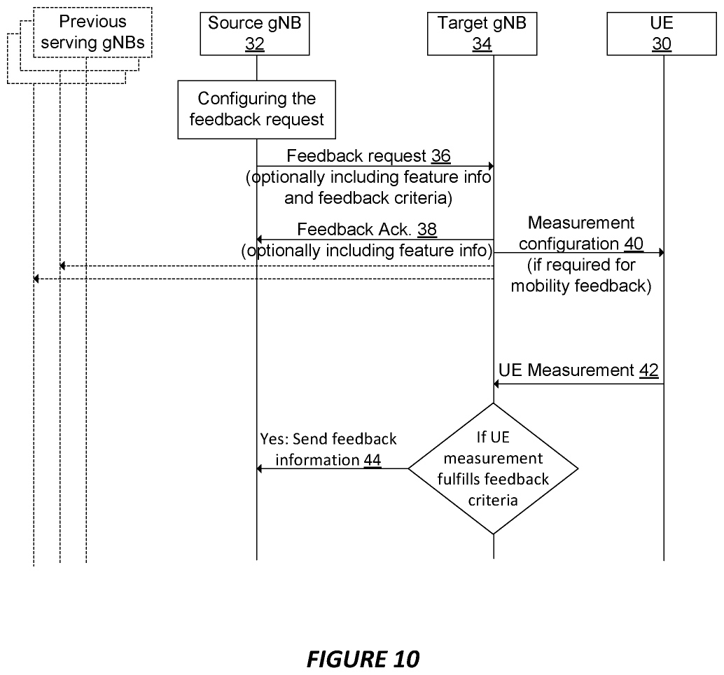

In another embodiment, the source node 32 still requests to receive feedback information 44 from the target node 32. This can be used to evaluate or update the ML model. In order to limit the signaling in the execution step, though, the source node 32 feedback request 36 can also include a triggering criterion for sending feedback information 44. For example, the triggering criterion may be to send feedback information 44 if the UE throughput (or any of the metrics in previous section) is not above a certain value T. The threshold T can be selected for example based on the experience in its serving node (T is the current UE throughput for instance). Or in another embodiment, the triggering criterion may be to send feedback information 44 if the metric (e.g. throughput) in the target cell is not within the range of (T±ε). The overall aspects related to the ML aspects in this regard are shown in the flow chart in FIG. 10.

As shown in FIG. 10, the source node 32 may optionally include feature information and feedback criteria in the feedback request 36 to the target node 34. Alternatively or additionally, the target node 34 may optionally include feature information in the feedback acknowledgement 38.

As also shown in FIG. 10, the target node 34 may decide if the UE measurement 42 received from the UE 30 fulfills the feedback criteria included in the feedback request 36. If so, the target node 34 may send the feedback information 44. If not, the target node 34 may not send the feedback information 44.

This can in a related embodiment also be used in the training step for binary classification. That is to only signal feedback information if one or more metrics do not fulfill a certain criterion. If the source node 32 does not receive any feedback, then it knows that the output is 1, otherwise 0 (or vice versa). In another embodiment, the information relative to the configuration signaled from the target node 34 to the source node 32 after the HO execution may be used to train a model and to let it identify that certain conditions identified before the HO execution may lead to a certain UE configuration, and therefore to a given QoS for the UE, after the HO execution. For example, the model could be trained to learn from one or more of the following inputs: (i) the monitoring of measurement reports from the UE 30 on neighbor cells, where such cells reported include cells involved in a UE configuration applied to the UE at HO target node 34 after HO execution; (ii) the UE capabilities; (iii) the capacity, resource utilization and in general load information at the cells reported by the UE 30 before HO execution; and/or (iv) the capability of neighbor NG RAN nodes serving the cells reported by the UE 30 before HO execution, e.g. known via inter NG RAN node signaling or known via Operations and Maintenance (OAM) configuration.

The model after such training may be able to deduce from the above information that a given configuration is likely to be available for the UE 30 in certain cells and it can therefore steer the HO target selection function to handover the UE 30 to those cells where the most advantageous configuration can be applied, e.g. configurations that maximizes quality of experience (QoE) or configurations that minimize energy consumption or configurations that maximise service availability and reliability.

Consider now signaling the mobility feedback request 36 to the target cell. The RAN node owning the source cell may signal the mobility feedback request 36 over the Xn or NG interface to the neighbouring RAN node owning the target cell.

In another embodiment, the RAN node owning the source cell may use the Handover Preparation Procedure (e.g. handover request message) or use a dedicated signal to send the mobility feedback request 36 to the RAN node owning the target cell of the handover.

In yet another embodiment, the RAN node owning the source cell may send the mobility feedback signal to multiple potential RAN nodes owning the potential target cells if the handover is configured to be conditional handover.

Consider now actions taken by the RAN node owning the target cell of the HO. In response to the handover feedback request 36, the RAN node owning the target cell may provide the collected measurement, such as statistics related to the throughput, traffic pattern, any changes in service types and QoS requirements such as the allocated data bearers, cell dwelling time, number of retransitions from RRC_IDLE or RRC_Inactive to RRC_Connected mode.

In response to the handover feedback request 36, a RAN node owning the target cell may configure the UE 30 to measure the RRM measurement of the frequencies requested by the RAN node owning the source cell of the HO. In one embodiment, the UE 30 may be configured to perform the measurements, requested by the RAN node owning the serving cell, as part of Handover Preparation Procedure i.e., Handover Request Acknowledge signal. In another embodiment, the UE 30 may be configured with measurement of the given frequencies when the UE 30 successfully performed the handover to the target cell.

In an alternative method, a RAN node owning the source cell may configure the UE 30 to measure the RRM measurement of the frequencies of interest before handover completion, e.g. as part of the Handover command or as part of any other signaling message before the handover is triggered or before the handover is completed.

In one embodiment, the above configuration is provisioned to the UE 30 by the source cell, upon acknowledgment from the target node 34. In another embodiment, the above configuration is provisioned to the UE 30 by the source cell, and the source cell notifies the target cell that the UE 30 has been configured with a certain measurement report.

The first method (depicted in FIG. 3) may be used to report measurements related to UE performances after the handover, while the second method (depicted in FIG. 6) may be used to report UE performances during the HO.

In another embodiment, a RAN node may request the UE 30 to provide/signal the statistics concerning the UE's quality of experience e.g., statistics related to the jitter (max, min, mean and instantaneous jitter values) for guaranteed bit rate services such as VOIP over LTE and NR.

In yet another embodiment, the RAN node owning the target cell may request the UE 30 to provide/signal the uplink/downlink throughput measurement experienced by the UE 30.

Consider now signaling mobility history information to the previous cells. A RAN node receiving the mobility history information 46 from the UE 30 may signal the mobility history information of the UE 30 over Xn or NG interfaces to the RAN nodes included in the last visited cells of the mobility history information IE received from the UE 30. A RAN node receiving the mobility history information from another RAN node may signal the mobility history information 46 to the previous RAN node owning a cell included in the last visited cells.

In yet another embodiment, a RAN node may signal the UE History Information IE that is a network side counter (different from Mobility History information fetched from the UE) collecting the visited cells by the UE only in RRC_Connected mode.

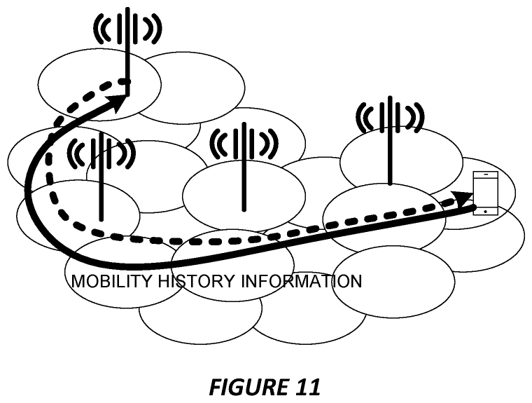

FIG. 11 in this regard shows an example of signaling mobility history information 46 of the UE 30 to the RAN nodes owning the cells included as part of last visited cells of the mobility history information 46 of the UE 30.

Consider now aspects related to request and receiving feedback from Access and Mobility Function (AMF) or OAM. In some embodiments, a RAN node owning a serving cell may request to the OAM or AMF (e.g., over NG or S1 interfaces) to provide additional information related to the UEs handed over to the other neighbouring cells. Information requested by the RAN node may include (i) Logged Minimization of Drive Test (MDT) measurements performed by the UE 30; (ii) Immediate MDT measurements provided by the UE 30; (iii) Accessibility measurements collected by the UE 30; (iv) Radio link failure related measurements collected by the UE 30; and/or (v) UE mobility history information.

In response to the request for the feedback from the RAN node owning a serving cell, the OAM or AMF may provide all or some of the above-mentioned information to the RAN node.

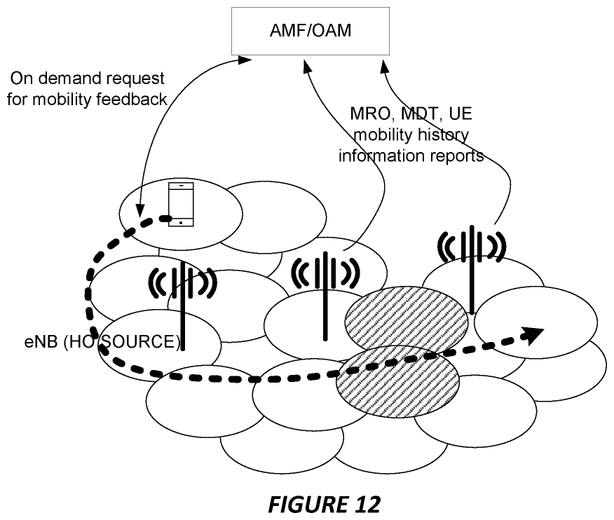

Such information may assist the RAN node to build the coverage map of different frequency layers over the UE trajectory and hence steer the UE 30 toward the possible radio route with the best coverage or guaranteeing the UE's quality of service requirements. FIG. 12 for example shows one example of requesting feedback from the AMF/OAM. Feedback may include information concerning logged and immediate MDT, Accessibility measurement as well as RLF related to the UEs handed over from the serving cell to the neighbouring cells.

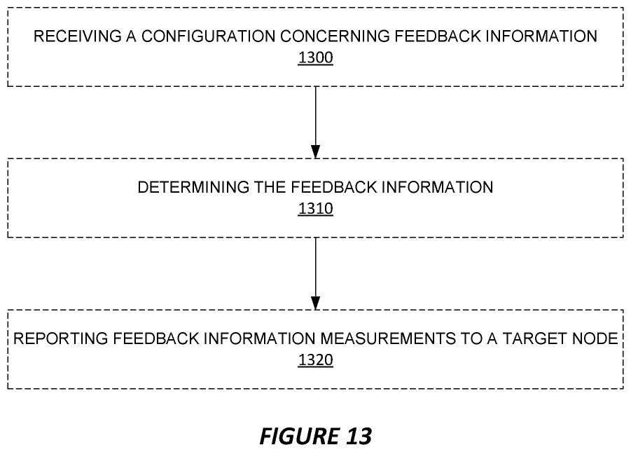

Generally, then, some embodiments herein comprise a method performed by a wireless terminal (also called User Equipment—UE), as shown in FIG. 13. The method comprises one or more of the following steps. In some embodiments, the method comprises receiving a configuration concerning feedback information (Block 1300). In one embodiment, the UE receives an RRCReconfiguration with a reconfiguration with sync including an indication that it shall perform at least one of the following actions: (i) Perform measurements to be reported to target upon HO execution e.g. in an RRCReconfigurationComplete; and (ii) Perform measurements to be possibly reported to target if request after a HO e.g. in a UE Information request like message.

In some embodiments, the method comprises determining the feedback information e.g. by performing measurements, by including available information in a report, by logging available information in a UE variable, etc. (Block 1310). The method may also comprise reporting feedback information measurements to a target node (Block 1320).

Generally, though, some embodiments herein provide triggers and configurations for beam measurement reporting upon accessing a target cell during handovers, conditional handovers, Secondary Cell Group (SCG) changes, SCG additions, where the former two include the E-UTRAN New Radio Dual Carrier (EN-DC) scenario.

Certain embodiments may provide one or more of the following technical advantage(s). As mentioned, current handover procedure in LTE and NR technologies is oblivious about the UE after performing the HO to the target cell. Some embodiments by contrast provide the possibility to the network to adapt the handover decisions based on the user experience and behavior after the handover. The information could be for example used as input to an AI/ML function that performs handover decisions so in the later occasions, handover decisions take into account possible future throughput a UE would experience in a certain target cell/node under previous radio conditions that are reported before the handovers. An AI/ML function could also take the prediction of the UEs position into account for a better handover configuration. For example, currently negotiation between serving and target cell about guaranteeing the QoS requirements of the UE (e.g., provisioning dedicated radio bearers) is limited to the Handover Preparation Procedure. If the UE switched between different services after handover, it would heretofore not be visible to the source cell whether the target cell is capable of handling the new QoS requirements. Some embodiments enable the RAN nodes owning the source and target cells to exchange the information about any changes in the radio bearers and QoS requirements of the UE. Hence, a RAN node owning the source cell would be able to select a suitable target cell considering any predictable changes in the UE behavior.

In addition, signaling the UE history information to the last visited cells, beside the coverage related measurements such as MDT and RRM based measurements would allow the cells to steer the UE toward the cells with the optimized quality not only considering the radio coverage but also the user's quality of experience accounting for variability of the UE's QoS requirement after handover.

Note that the term handover is used herein to include a reconfiguration with sync, i.e. a procedure where the UE receives a message (and/or applies a message) from the network (e.g. RRCReconfiguration including a reconfigurationWithSync in a CellGroupConfig), and, upon reception, performs random access to a target cell followed by the transmission of an RRCReconfigurationComplete like message. Hence, embodiments herein may be applicable upon other types of reconfiguration procedures such as the following.

One type of reconfiguration procedure may be a PSCell addition (i.e. throughput measurements when a PSCell is being added). In this case, the source node 32 described above can be a Master Node (MN) gNodeB or eNodeB.

Another type of reconfiguration procedure is a PSCell change (i.e. throughput measurements when a PSCell is being changed, in the same Secondary node and/or in a different Secondary node). In this case, the source node 32 described above can be a source Secondary Node (s-SN) gNodeB or eNodeB, while the target node 34 can be a target Secondary Node (SN) (t-SN).

Yet another type of reconfiguration procedure is a Conditional Handover (CHO) (i.e. throughput measurements when UE executes CHO towards a target cell).

Another type of reconfiguration procedure is a Conditional PSCell Addition (i.e. throughput measurements when a PSCell is being added). In this case, the source node 32 described above can be a Master Node (MN) gNodeB or eNodeB.

A further type of reconfiguration procedure is a Conditional PSCell Change (i.e. throughput measurements when a PSCell is being changed, in the same Secondary node and/or in a different Secondary node). In this case, the source node 32 described above can be a source Secondary Node (s-SN) gNodeB or eNodeB, while the target node 34 can be a target SN (t-SN), which could be a target candidate that becomes a target upon execution.

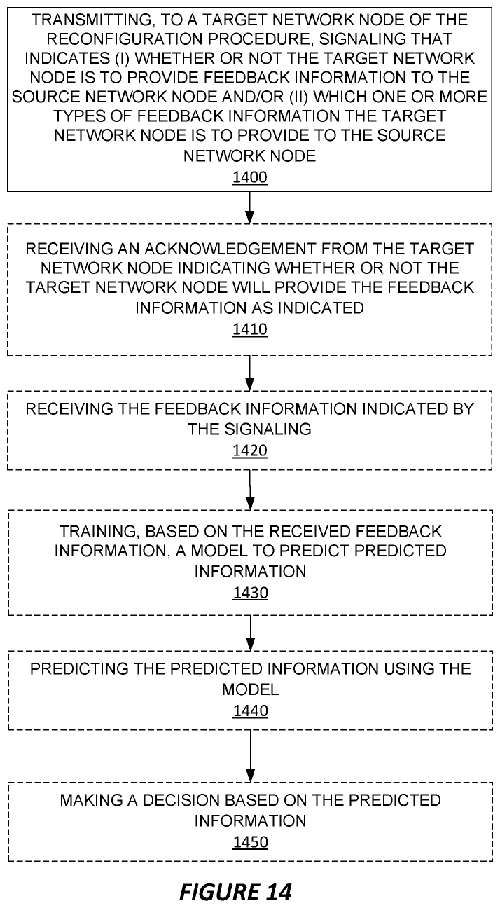

In view of the modifications and variations herein, FIG. 14 depicts a method performed by a network node configured to operate as a source network node 32 of a reconfiguration procedure in accordance with particular embodiments. The method comprises transmitting signaling to a target network node 34 of the reconfiguration procedure (Block 1400), e.g., included in a feedback request 36. The signaling may indicate whether or not the target network node 34 is to provide feedback information 44 to the source network node 32. Additionally or alternatively, the signaling may indicate which one or more types of feedback information 44 the target network node 34 is to provide to the source network node 32.

In some embodiments, the feedback information 44 includes at least one of any one or more of the following types of feedback information 44: information about the reconfiguration procedure, information about a wireless device 30 that performs the reconfiguration procedure, information about the target network node 34 or a target cell during or after the reconfiguration procedure, one or more measurements performed by the target network node 34 during and/or after the reconfiguration procedure, and one or more measurements performed by the wireless device 30 during and/or after the reconfiguration procedure.

In some embodiments, the feedback information 44 includes information about a configuration adopted for a wireless device 30 after the wireless device 30 performs the reconfiguration procedure. In one or more of these embodiments, the information about the configuration adopted for the wireless device 30 includes information about at least one of any one or more of: a dual connectivity configuration adopted for the wireless device 30 after the wireless device 30 performs the reconfiguration procedure, a carrier aggregation configuration adopted for the wireless device 30 after the wireless device 30 performs the reconfiguration procedure, and a feature set and/or band combination adopted for the wireless device 30 after the wireless device 30 performs the reconfiguration procedure.

In some embodiments, the feedback information 44 includes information about a configuration at the target network node 34 during and/or after the reconfiguration procedure. In one or more of these embodiments, the information about the configuration at the target network node 34 during and/or after the reconfiguration procedure includes information about at least one of any one or more of: overall capacity utilized by a wireless device 30 at the target network node 34, overall percentage of physical resource blocks used by a wireless device 30 at a target cell of the reconfiguration procedure, and overall throughput achieved via a configuration applied at a wireless device 30 after the wireless device 30 performs the reconfiguration procedure.

In some embodiments, the signaling indicates a time window within which the feedback information 44 is requested from the target network node 34 after execution of the reconfiguration procedure.

In some embodiments, the signaling indicates a criterion that is to trigger the target network node 34 to transmit a type of feedback information 44 to the source network node 32. In this case, the criterion is that a value of the type of feedback information 44 is below a threshold, is above a threshold, is outside of a range, or is inside of a range, and the signaling indicates the threshold or the range.

In some embodiments, the method further comprises receiving an acknowledgement 38 from the target network node 34 indicating whether or not the target network node 34 will provide the feedback information 44 as indicated (Block 1410).

In some embodiments, the method alternatively or additionally further comprises receiving the feedback information 44 indicated by the signaling (Block 1420). In one or more of these embodiments, the method further comprises training, based on the received feedback information 44, a model to predict predicted information (Block 1430), predicting the predicted information using the model (Block 1440), and making a decision based on the predicted information (Block 1450). In one or more of these embodiments, the decision is a decision about whether a wireless device 30 is to perform a reconfiguration procedure to the target network node 34, which wireless device 30 is to perform a reconfiguration procedure to the target network node 34, or which network node is to be a target of a reconfiguration procedure to be performed by a wireless device 30.

In some embodiments, the reconfiguration procedure is a mobility procedure, a PSCell addition or change procedure, or a conditional reconfiguration procedure.

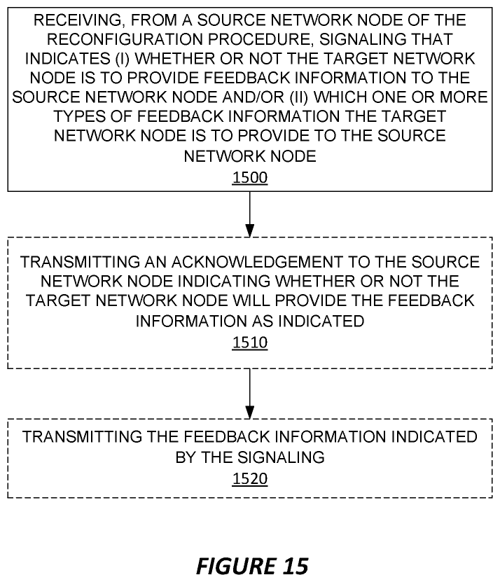

FIG. 15 depicts a method performed by a network node configured to operate as a target network node 34 of a reconfiguration procedure in accordance with other particular embodiments. The method comprises receiving signaling from a source network node 32 of the reconfiguration procedure, e.g., included in a feedback request 36 (Block 1500). The signaling indicates (i) whether or not the target network node 34 is to provide feedback information 44 to the source network node 32; and/or (ii) which one or more types of feedback information 44 the target network node 34 is to provide to the source network node 32.

In some embodiments, the feedback information 44 includes at least one of any one or more of the following types of feedback information 44: information about the reconfiguration procedure, information about a wireless device 30 that performs the reconfiguration procedure, information about the target network node 34 or a target cell during or after the reconfiguration procedure, one or more measurements performed by the target network node 34 during and/or after the reconfiguration procedure, and one or more measurements performed by the wireless device 30 during and/or after the reconfiguration procedure.

In some embodiments, the feedback information 44 includes information about a configuration adopted for a wireless device 30 after the wireless device 30 performs the reconfiguration procedure. In one or more of these embodiments, the information about the configuration adopted for the wireless device 30 includes information about at least one of any one or more of: a dual connectivity configuration adopted for the wireless device 30 after the wireless device 30 performs the reconfiguration procedure, a carrier aggregation configuration adopted for the wireless device 30 after the wireless device 30 performs the reconfiguration procedure, and a feature set and/or band combination adopted for the wireless device 30 after the wireless device 30 performs the reconfiguration procedure.

In some embodiments, the feedback information 44 includes information about a configuration at the target network node 34 during and/or after the reconfiguration procedure. In one or more of these embodiments, the information about the configuration at the target network node 34 during and/or after the reconfiguration procedure includes information about at least one of any one or more of: overall capacity utilized by a wireless device 30 at the target network node 34, overall percentage of physical resource blocks used by a wireless device 30 at a target cell of the reconfiguration procedure, and overall throughput achieved via a configuration applied at a wireless device 30 after the wireless device 30 performs the reconfiguration procedure.

In some embodiments, wherein the signaling indicates a time window within which the feedback information 44 is requested from the target network node 34 after execution of the reconfiguration procedure.

In some embodiments, the signaling indicates a criterion that is to trigger the target network node 34 to transmit a type of feedback information 44 to the source network node 32. In this case, the criterion is that a value of the type of feedback information 44 is below a threshold, is above a threshold, is outside of a range, or is inside of a range, and the signaling indicates the threshold or the range.

In some embodiments, the method further comprises transmitting an acknowledgement 38 to the source network node 32 indicating whether or not the target network node 34 will provide the feedback information 44 as indicated (Block 1510).

In some embodiments, the method further comprises deciding, based on the received signaling, whether to transmit feedback information 44 to the source network node 32. Additionally or alternatively, the method further comprises deciding, based on the received signaling, which one or more types of feedback information 44 to transmit to the source network node 32.

In some embodiments, the method further comprises transmitting, to the source network node 32, the feedback information 44 indicated by the signaling (Block 1520).

In some embodiments, the reconfiguration procedure is a mobility procedure, a PSCell addition or change procedure, or a conditional reconfiguration procedure.

Embodiments herein also include corresponding apparatuses. Embodiments herein for instance include a wireless device configured to perform any of the steps of any of the embodiments described above for the wireless device.

Embodiments also include a wireless device 30 comprising processing circuitry and power supply circuitry. The processing circuitry is configured to perform any of the steps of any of the embodiments described above for the wireless device 30. The power supply circuitry is configured to supply power to the wireless device 30.

Embodiments further include a wireless device 30 comprising processing circuitry. The processing circuitry is configured to perform any of the steps of any of the embodiments described above for the wireless device 30. In some embodiments, the wireless device 30 further comprises communication circuitry.

Embodiments further include a wireless device 30 comprising processing circuitry and memory. The memory contains instructions executable by the processing circuitry whereby the wireless device 30 is configured to perform any of the steps of any of the embodiments described above for the wireless device 30.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 30. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node configured to perform any of the steps of any of the embodiments described above for the source network node 34 or the target network node 32.

Embodiments also include a network node comprising processing circuitry and power supply circuitry. The processing circuitry is configured to perform any of the steps of any of the embodiments described above for the source network node 34 or the target network node 32. The power supply circuitry is configured to supply power to the network node.

Embodiments further include a network node comprising processing circuitry. The processing circuitry is configured to perform any of the steps of any of the embodiments described above for the source network node 34 or the target network node 32. In some embodiments, the network node further comprises communication circuitry.

Embodiments further include a network node comprising processing circuitry and memory. The memory contains instructions executable by the processing circuitry whereby the network node is configured to perform any of the steps of any of the embodiments described above for the source network node 34 or the target network node 32.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

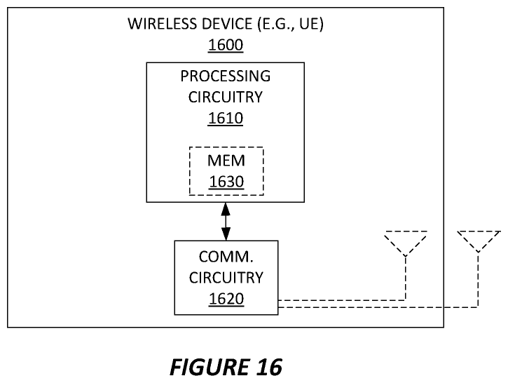

FIG. 16 for example illustrates a wireless device 1600 as implemented in accordance with one or more embodiments. As shown, the wireless device 1600 includes processing circuitry 1610 and communication circuitry 1620. The communication circuitry 1620 (e.g., radio circuitry) is configured to transmit and/or receive information to and/or from one or more other nodes, e.g., via any communication technology. Such communication may occur via one or more antennas that are either internal or external to the wireless device 1600. The processing circuitry 1610 is configured to perform processing described above, e.g., in FIG. 13, such as by executing instructions stored in memory 1630. The processing circuitry 1610 in this regard may implement certain functional means, units, or modules.

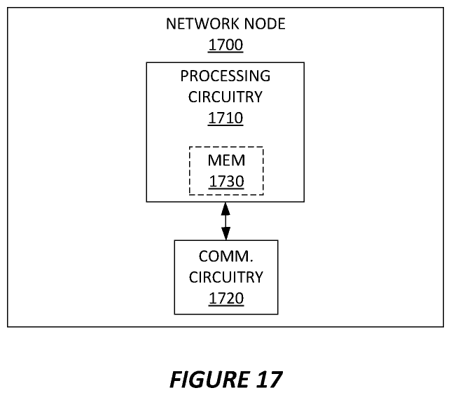

FIG. 17 illustrates a network node 1700 (e.g., a source network node 32 or a target network node 34) as implemented in accordance with one or more embodiments. As shown, the network node 1700 includes processing circuitry 1710 and communication circuitry 1720. The communication circuitry 1720 is configured to transmit and/or receive information to and/or from one or more other nodes, e.g., via any communication technology. The processing circuitry 1710 is configured to perform processing described above, e.g., in FIG. 14 or FIG. 15, such as by executing instructions stored in memory 1730. The processing circuitry 1710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

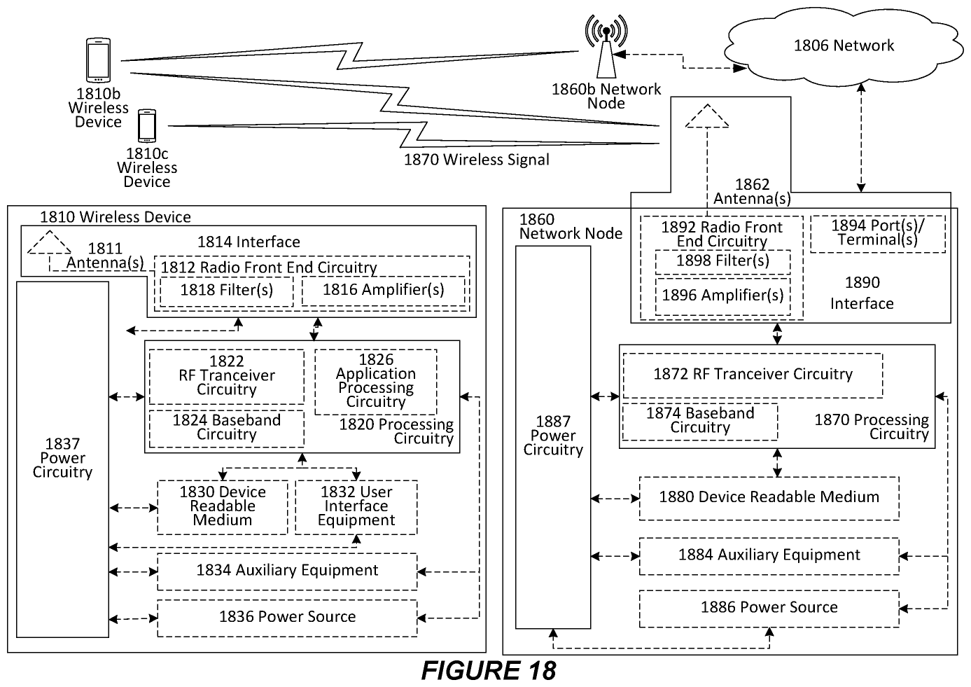

Although the subject matter described herein may be implemented in any appropriate type of system using any suitable components, the embodiments disclosed herein are described in relation to a wireless network, such as the example wireless network illustrated in FIG. 18. For simplicity, the wireless network of FIG. 18 only depicts network 1806, network nodes 1860 and 1860b, and WDs 1810, 1810b, and 1810c. In practice, a wireless network may further include any additional elements suitable to support communication between wireless devices or between a wireless device and another communication device, such as a landline telephone, a service provider, or any other network node or end device. Of the illustrated components, network node 1860 and wireless device (WD) 1810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1860 and WD 1810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 18, network node 1860 includes processing circuitry 1870, device readable medium 1880, interface 1890, auxiliary equipment 1884, power source 1886, power circuitry 1887, and antenna 1862. Although network node 1860 illustrated in the example wireless network of FIG. 18 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1860 are depicted as single boxes located within a larger box, or nested within multiple boxes, in practice, a network node may comprise multiple different physical components that make up a single illustrated component (e.g., device readable medium 1880 may comprise multiple separate hard drives as well as multiple RAM modules).

Similarly, network node 1860 may be composed of multiple physically separate components (e.g., a NodeB component and a RNC component, or a BTS component and a BSC component, etc.), which may each have their own respective components. In certain scenarios in which network node 1860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1860 may be configured to support multiple radio access technologies (RATs). In such embodiments, some components may be duplicated (e.g., separate device readable medium 1880 for the different RATs) and some components may be reused (e.g., the same antenna 1862 may be shared by the RATs). Network node 1860 may also include multiple sets of the various illustrated components for different wireless technologies integrated into network node 1860, such as, for example, GSM, WCDMA, LTE, NR, WiFi, or Bluetooth wireless technologies. These wireless technologies may be integrated into the same or different chip or set of chips and other components within network node 1860.

Processing circuitry 1870 is configured to perform any determining, calculating, or similar operations (e.g., certain obtaining operations) described herein as being provided by a network node. These operations performed by processing circuitry 1870 may include processing information obtained by processing circuitry 1870 by, for example, converting the obtained information into other information, comparing the obtained information or converted information to information stored in the network node, and/or performing one or more operations based on the obtained information or converted information, and as a result of said processing making a determination.

Processing circuitry 1870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1860 components, such as device readable medium 1880, network node 1860 functionality. For example, processing circuitry 1870 may execute instructions stored in device readable medium 1880 or in memory within processing circuitry 1870. Such functionality may include providing any of the various wireless features, functions, or benefits discussed herein. In some embodiments, processing circuitry 1870 may include a system on a chip (SOC).

In some embodiments, processing circuitry 1870 may include one or more of radio frequency (RF) transceiver circuitry 1872 and baseband processing circuitry 1874. In some embodiments, radio frequency (RF) transceiver circuitry 1872 and baseband processing circuitry 1874 may be on separate chips (or sets of chips), boards, or units, such as radio units and digital units. In alternative embodiments, part or all of RF transceiver circuitry 1872 and baseband processing circuitry 1874 may be on the same chip or set of chips, boards, or units

In certain embodiments, some or all of the functionality described herein as being provided by a network node, base station, eNB or other such network device may be performed by processing circuitry 1870 executing instructions stored on device readable medium 1880 or memory within processing circuitry 1870. In alternative embodiments, some or all of the functionality may be provided by processing circuitry 1870 without executing instructions stored on a separate or discrete device readable medium, such as in a hard-wired manner. In any of those embodiments, whether executing instructions stored on a device readable storage medium or not, processing circuitry 1870 can be configured to perform the described functionality. The benefits provided by such functionality are not limited to processing circuitry 1870 alone or to other components of network node 1860, but are enjoyed by network node 1860 as a whole, and/or by end users and the wireless network generally.

Device readable medium 1880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1870. Device readable medium 1880 may store any suitable instructions, data or information, including a computer program, software, an application including one or more of logic, rules, code, tables, etc. and/or other instructions capable of being executed by processing circuitry 1870 and, utilized by network node 1860. Device readable medium 1880 may be used to store any calculations made by processing circuitry 1870 and/or any data received via interface 1890. In some embodiments, processing circuitry 1870 and device readable medium 1880 may be considered to be integrated.

Interface 1890 is used in the wired or wireless communication of signalling and/or data between network node 1860, network 1806, and/or WDs 1810. As illustrated, interface 1890 comprises port(s)/terminal(s) 1894 to send and receive data, for example to and from network 1806 over a wired connection. Interface 1890 also includes radio front end circuitry 1892 that may be coupled to, or in certain embodiments a part of, antenna 1862. Radio front end circuitry 1892 comprises filters 1898 and amplifiers 1896. Radio front end circuitry 1892 may be connected to antenna 1862 and processing circuitry 1870. Radio front end circuitry may be configured to condition signals communicated between antenna 1862 and processing circuitry 1870. Radio front end circuitry 1892 may receive digital data that is to be sent out to other network nodes or WDs via a wireless connection. Radio front end circuitry 1892 may convert the digital data into a radio signal having the appropriate channel and bandwidth parameters using a combination of filters 1898 and/or amplifiers 1896. The radio signal may then be transmitted via antenna 1862. Similarly, when receiving data, antenna 1862 may collect radio signals which are then converted into digital data by radio front end circuitry 1892. The digital data may be passed to processing circuitry 1870. In other embodiments, the interface may comprise different components and/or different combinations of components.

In certain alternative embodiments, network node 1860 may not include separate radio front end circuitry 1892, instead, processing circuitry 1870 may comprise radio front end circuitry and may be connected to antenna 1862 without separate radio front end circuitry 1892. Similarly, in some embodiments, all or some of RF transceiver circuitry 1872 may be considered a part of interface 1890. In still other embodiments, interface 1890 may include one or more ports or terminals 1894, radio front end circuitry 1892, and RF transceiver circuitry 1872, as part of a radio unit (not shown), and interface 1890 may communicate with baseband processing circuitry 1874, which is part of a digital unit (not shown).

Antenna 1862 may include one or more antennas, or antenna arrays, configured to send and/or receive wireless signals. Antenna 1862 may be coupled to radio front end circuitry 1890 and may be any type of antenna capable of transmitting and receiving data and/or signals wirelessly. In some embodiments, antenna 1862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1862 may be separate from network node 1860 and may be connectable to network node 1860 through an interface or port.

Antenna 1862, interface 1890, and/or processing circuitry 1870 may be configured to perform any receiving operations and/or certain obtaining operations described herein as being performed by a network node. Any information, data and/or signals may be received from a wireless device, another network node and/or any other network equipment. Similarly, antenna 1862, interface 1890, and/or processing circuitry 1870 may be configured to perform any transmitting operations described herein as being performed by a network node. Any information, data and/or signals may be transmitted to a wireless device, another network node and/or any other network equipment.

Power circuitry 1887 may comprise, or be coupled to, power management circuitry and is configured to supply the components of network node 1860 with power for performing the functionality described herein. Power circuitry 1887 may receive power from power source 1886. Power source 1886 and/or power circuitry 1887 may be configured to provide power to the various components of network node 1860 in a form suitable for the respective components (e.g., at a voltage and current level needed for each respective component). Power source 1886 may either be included in, or external to, power circuitry 1887 and/or network node 1860. For example, network node 1860 may be connectable to an external power source (e.g., an electricity outlet) via an input circuitry or interface such as an electrical cable, whereby the external power source supplies power to power circuitry 1887. As a further example, power source 1886 may comprise a source of power in the form of a battery or battery pack which is connected to, or integrated in, power circuitry 1887. The battery may provide backup power should the external power source fail. Other types of power sources, such as photovoltaic devices, may also be used.

Alternative embodiments of network node 1860 may include additional components beyond those shown in FIG. 18 that may be responsible for providing certain aspects of the network node's functionality, including any of the functionality described herein and/or any functionality necessary to support the subject matter described herein. For example, network node 1860 may include user interface equipment to allow input of information into network node 1860 and to allow output of information from network node 1860. This may allow a user to perform diagnostic, maintenance, repair, and other administrative functions for network node 1860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1810 includes antenna 1811, interface 1814, processing circuitry 1820, device readable medium 1830, user interface equipment 1832, auxiliary equipment 1834, power source 1836 and power circuitry 1837. WD 1810 may include multiple sets of one or more of the illustrated components for different wireless technologies supported by WD 1810, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1810.

Antenna 1811 may include one or more antennas or antenna arrays, configured to send and/or receive wireless signals, and is connected to interface 1814. In certain alternative embodiments, antenna 1811 may be separate from WD 1810 and be connectable to WD 1810 through an interface or port. Antenna 1811, interface 1814, and/or processing circuitry 1820 may be configured to perform any receiving or transmitting operations described herein as being performed by a WD. Any information, data and/or signals may be received from a network node and/or another WD. In some embodiments, radio front end circuitry and/or antenna 1811 may be considered an interface.

As illustrated, interface 1814 comprises radio front end circuitry 1812 and antenna 1811. Radio front end circuitry 1812 comprise one or more filters 1818 and amplifiers 1816. Radio front end circuitry 1814 is connected to antenna 1811 and processing circuitry 1820, and is configured to condition signals communicated between antenna 1811 and processing circuitry 1820. Radio front end circuitry 1812 may be coupled to or a part of antenna 1811. In some embodiments, WD 1810 may not include separate radio front end circuitry 1812; rather, processing circuitry 1820 may comprise radio front end circuitry and may be connected to antenna 1811. Similarly, in some embodiments, some or all of RF transceiver circuitry 1822 may be considered a part of interface 1814. Radio front end circuitry 1812 may receive digital data that is to be sent out to other network nodes or WDs via a wireless connection. Radio front end circuitry 1812 may convert the digital data into a radio signal having the appropriate channel and bandwidth parameters using a combination of filters 1818 and/or amplifiers 1816. The radio signal may then be transmitted via antenna 1811. Similarly, when receiving data, antenna 1811 may collect radio signals which are then converted into digital data by radio front end circuitry 1812. The digital data may be passed to processing circuitry 1820. In other embodiments, the interface may comprise different components and/or different combinations of components.

Processing circuitry 1820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1810 components, such as device readable medium 1830, WD 1810 functionality. Such functionality may include providing any of the various wireless features or benefits discussed herein. For example, processing circuitry 1820 may execute instructions stored in device readable medium 1830 or in memory within processing circuitry 1820 to provide the functionality disclosed herein.

As illustrated, processing circuitry 1820 includes one or more of RF transceiver circuitry 1822, baseband processing circuitry 1824, and application processing circuitry 1826. In other embodiments, the processing circuitry may comprise different components and/or different combinations of components. In certain embodiments processing circuitry 1820 of WD 1810 may comprise a SOC. In some embodiments, RF transceiver circuitry 1822, baseband processing circuitry 1824, and application processing circuitry 1826 may be on separate chips or sets of chips. In alternative embodiments, part or all of baseband processing circuitry 1824 and application processing circuitry 1826 may be combined into one chip or set of chips, and RF transceiver circuitry 1822 may be on a separate chip or set of chips. In still alternative embodiments, part or all of RF transceiver circuitry 1822 and baseband processing circuitry 1824 may be on the same chip or set of chips, and application processing circuitry 1826 may be on a separate chip or set of chips. In yet other alternative embodiments, part or all of RF transceiver circuitry 1822, baseband processing circuitry 1824, and application processing circuitry 1826 may be combined in the same chip or set of chips. In some embodiments, RF transceiver circuitry 1822 may be a part of interface 1814. RF transceiver circuitry 1822 may condition RF signals for processing circuitry 1820.

In certain embodiments, some or all of the functionality described herein as being performed by a WD may be provided by processing circuitry 1820 executing instructions stored on device readable medium 1830, which in certain embodiments may be a computer-readable storage medium. In alternative embodiments, some or all of the functionality may be provided by processing circuitry 1820 without executing instructions stored on a separate or discrete device readable storage medium, such as in a hard-wired manner. In any of those particular embodiments, whether executing instructions stored on a device readable storage medium or not, processing circuitry 1820 can be configured to perform the described functionality. The benefits provided by such functionality are not limited to processing circuitry 1820 alone or to other components of WD 1810, but are enjoyed by WD 1810 as a whole, and/or by end users and the wireless network generally.

Processing circuitry 1820 may be configured to perform any determining, calculating, or similar operations (e.g., certain obtaining operations) described herein as being performed by a WD. These operations, as performed by processing circuitry 1820, may include processing information obtained by processing circuitry 1820 by, for example, converting the obtained information into other information, comparing the obtained information or converted information to information stored by WD 1810, and/or performing one or more operations based on the obtained information or converted information, and as a result of said processing making a determination.

Device readable medium 1830 may be operable to store a computer program, software, an application including one or more of logic, rules, code, tables, etc. and/or other instructions capable of being executed by processing circuitry 1820. Device readable medium 1830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1820. In some embodiments, processing circuitry 1820 and device readable medium 1830 may be considered to be integrated.

User interface equipment 1832 may provide components that allow for a human user to interact with WD 1810. Such interaction may be of many forms, such as visual, audial, tactile, etc. User interface equipment 1832 may be operable to produce output to the user and to allow the user to provide input to WD 1810. The type of interaction may vary depending on the type of user interface equipment 1832 installed in WD 1810. For example, if WD 1810 is a smart phone, the interaction may be via a touch screen; if WD 1810 is a smart meter, the interaction may be through a screen that provides usage (e.g., the number of gallons used) or a speaker that provides an audible alert (e.g., if smoke is detected). User interface equipment 1832 may include input interfaces, devices and circuits, and output interfaces, devices and circuits. User interface equipment 1832 is configured to allow input of information into WD 1810, and is connected to processing circuitry 1820 to allow processing circuitry 1820 to process the input information. User interface equipment 1832 may include, for example, a microphone, a proximity or other sensor, keys/buttons, a touch display, one or more cameras, a USB port, or other input circuitry. User interface equipment 1832 is also configured to allow output of information from WD 1810, and to allow processing circuitry 1820 to output information from WD 1810. User interface equipment 1832 may include, for example, a speaker, a display, vibrating circuitry, a USB port, a headphone interface, or other output circuitry. Using one or more input and output interfaces, devices, and circuits, of user interface equipment 1832, WD 1810 may communicate with end users and/or the wireless network, and allow them to benefit from the functionality described herein.

Auxiliary equipment 1834 is operable to provide more specific functionality which may not be generally performed by WDs. This may comprise specialized sensors for doing measurements for various purposes, interfaces for additional types of communication such as wired communications etc. The inclusion and type of components of auxiliary equipment 1834 may vary depending on the embodiment and/or scenario.

Power source 1836 may, in some embodiments, be in the form of a battery or battery pack. Other types of power sources, such as an external power source (e.g., an electricity outlet), photovoltaic devices or power cells, may also be used. WD 1810 may further comprise power circuitry 1837 for delivering power from power source 1836 to the various parts of WD 1810 which need power from power source 1836 to carry out any functionality described or indicated herein. Power circuitry 1837 may in certain embodiments comprise power management circuitry. Power circuitry 1837 may additionally or alternatively be operable to receive power from an external power source; in which case WD 1810 may be connectable to the external power source (such as an electricity outlet) via input circuitry or an interface such as an electrical power cable. Power circuitry 1837 may also in certain embodiments be operable to deliver power from an external power source to power source 1836. This may be, for example, for the charging of power source 1836. Power circuitry 1837 may perform any formatting, converting, or other modification to the power from power source 1836 to make the power suitable for the respective components of WD 1810 to which power is supplied.

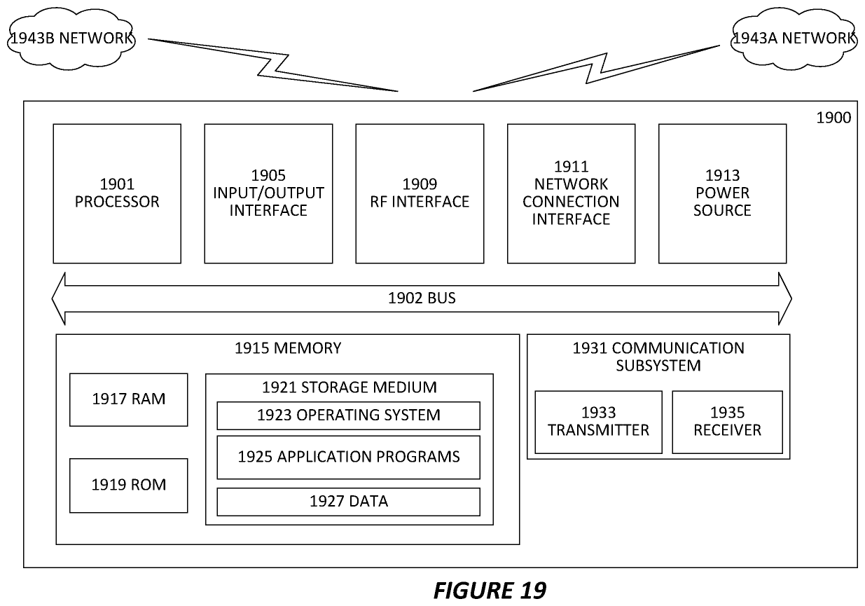

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 19200 may be any UE identified by the 3^{rd} Generation Partnership Project (3GPP), including a NB-IoT UE, a machine type communication (MTC) UE, and/or an enhanced MTC (eMTC) UE. UE 1900, as illustrated in FIG. 19, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 19 is a UE, the components discussed herein are equally applicable to a WD, and vice-versa.

In FIG. 19, UE 1900 includes processing circuitry 1901 that is operatively coupled to input/output interface 1905, radio frequency (RF) interface 1909, network connection interface 1911, memory 1915 including random access memory (RAM) 1917, read-only memory (ROM) 1919, and storage medium 1921 or the like, communication subsystem 1931, power source 1933, and/or any other component, or any combination thereof. Storage medium 1921 includes operating system 1923, application program 1925, and data 1927. In other embodiments, storage medium 1921 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1901 may be configured to process computer instructions and data. Processing circuitry 1901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1901 may include two central processing units (CPUs). Data may be information in a form suitable for use by a computer.

In the depicted embodiment, input/output interface 1905 may be configured to provide a communication interface to an input device, output device, or input and output device. UE 1900 may be configured to use an output device via input/output interface 1905. An output device may use the same type of interface port as an input device. For example, a USB port may be used to provide input to and output from UE 1900. The output device may be a speaker, a sound card, a video card, a display, a monitor, a printer, an actuator, an emitter, a smartcard, another output device, or any combination thereof. UE 1900 may be configured to use an input device via input/output interface 1905 to allow a user to capture information into UE 1900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1909 may be configured to provide a communication interface to RF components such as a transmitter, a receiver, and an antenna. Network connection interface 1911 may be configured to provide a communication interface to network 1943a. Network 1943a may encompass wired and/or wireless networks such as a local-area network (LAN), a wide-area network (WAN), a computer network, a wireless network, a telecommunications network, another like network or any combination thereof. For example, network 1943a may comprise a Wi-Fi network. Network connection interface 1911 may be configured to include a receiver and a transmitter interface used to communicate with one or more other devices over a communication network according to one or more communication protocols, such as Ethernet, TCP/IP, SONET, ATM, or the like. Network connection interface 1911 may implement receiver and transmitter functionality appropriate to the communication network links (e.g., optical, electrical, and the like). The transmitter and receiver functions may share circuit components, software or firmware, or alternatively may be implemented separately.

RAM 1917 may be configured to interface via bus 1902 to processing circuitry 1901 to provide storage or caching of data or computer instructions during the execution of software programs such as the operating system, application programs, and device drivers. ROM 1919 may be configured to provide computer instructions or data to processing circuitry 1901. For example, ROM 1919 may be configured to store invariant low-level system code or data for basic system functions such as basic input and output (I/O), startup, or reception of keystrokes from a keyboard that are stored in a non-volatile memory. Storage medium 1921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1921 may be configured to include operating system 1923, application program 1925 such as a web browser application, a widget or gadget engine or another application, and data file 1927. Storage medium 1921 may store, for use by UE 1900, any of a variety of various operating systems or combinations of operating systems.

Storage medium 1921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1921 may allow UE 1900 to access computer-executable instructions, application programs or the like, stored on transitory or non-transitory memory media, to off-load data, or to upload data. An article of manufacture, such as one utilizing a communication system may be tangibly embodied in storage medium 1921, which may comprise a device readable medium.

In FIG. 19, processing circuitry 1901 may be configured to communicate with network 1943b using communication subsystem 1931. Network 1943a and network 1943b may be the same network or networks or different network or networks. Communication subsystem 1931 may be configured to include one or more transceivers used to communicate with network 1943b. For example, communication subsystem 1931 may be configured to include one or more transceivers used to communicate with one or more remote transceivers of another device capable of wireless communication such as another WD, UE, or base station of a radio access network (RAN) according to one or more communication protocols, such as IEEE 802.19, CDMA, WCDMA, GSM, LTE, UTRAN, WiMax, or the like. Each transceiver may include transmitter 1933 and/or receiver 1935 to implement transmitter or receiver functionality, respectively, appropriate to the RAN links (e.g., frequency allocations and the like). Further, transmitter 1933 and receiver 1935 of each transceiver may share circuit components, software or firmware, or alternatively may be implemented separately.

In the illustrated embodiment, the communication functions of communication subsystem 1931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1931 may include cellular communication, Wi-Fi communication, Bluetooth communication, and GPS communication. Network 1943b may encompass wired and/or wireless networks such as a local-area network (LAN), a wide-area network (WAN), a computer network, a wireless network, a telecommunications network, another like network or any combination thereof. For example, network 1943b may be a cellular network, a Wi-Fi network, and/or a near-field network. Power source 1913 may be configured to provide alternating current (AC) or direct current (DC) power to components of UE 1900.

The features, benefits and/or functions described herein may be implemented in one of the components of UE 1900 or partitioned across multiple components of UE 1900. Further, the features, benefits, and/or functions described herein may be implemented in any combination of hardware, software or firmware. In one example, communication subsystem 1931 may be configured to include any of the components described herein. Further, processing circuitry 1901 may be configured to communicate with any of such components over bus 1902. In another example, any of such components may be represented by program instructions stored in memory that when executed by processing circuitry 1901 perform the corresponding functions described herein. In another example, the functionality of any of such components may be partitioned between processing circuitry 1901 and communication subsystem 1931. In another example, the non-computationally intensive functions of any of such components may be implemented in software or firmware and the computationally intensive functions may be implemented in hardware.

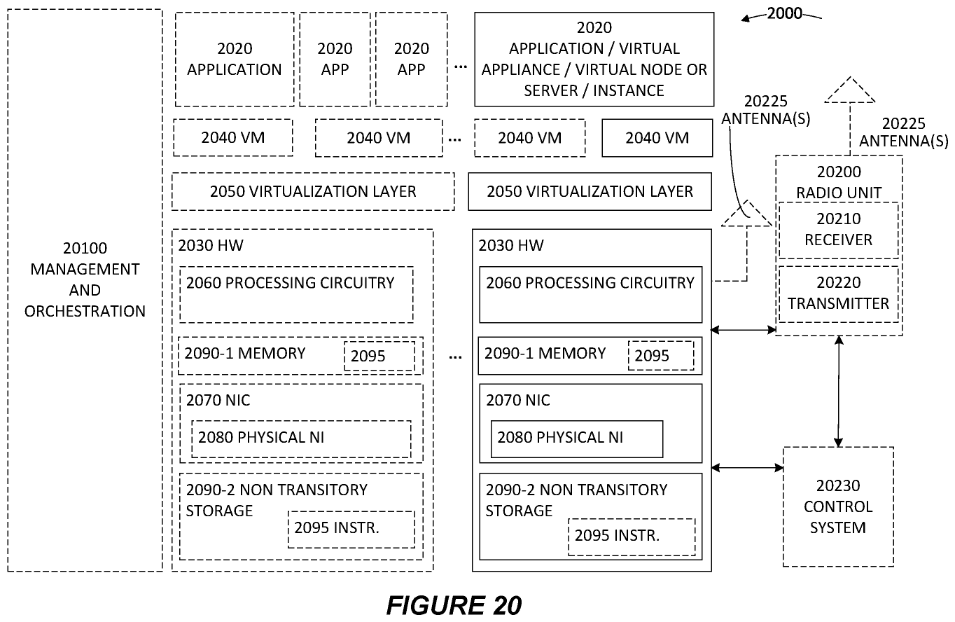

FIG. 20 is a schematic block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2000 hosted by one or more of hardware nodes 2030. Further, in embodiments in which the virtual node is not a radio access node or does not require radio connectivity (e.g., a core network node), then the network node may be entirely virtualized.

The functions may be implemented by one or more applications 2020 (which may alternatively be called software instances, virtual appliances, network functions, virtual nodes, virtual network functions, etc.) operative to implement some of the features, functions, and/or benefits of some of the embodiments disclosed herein. Applications 2020 are run in virtualization environment 2000 which provides hardware 2030 comprising processing circuitry 2060 and memory 2090. Memory 2090 contains instructions 2095 executable by processing circuitry 2060 whereby application 2020 is operative to provide one or more of the features, benefits, and/or functions disclosed herein.

Virtualization environment 2000, comprises general-purpose or special-purpose network hardware devices 2030 comprising a set of one or more processors or processing circuitry 2060, which may be commercial off-the-shelf (COTS) processors, dedicated Application Specific Integrated Circuits (ASICs), or any other type of processing circuitry including digital or analog hardware components or special purpose processors. Each hardware device may comprise memory 2090-1 which may be non-persistent memory for temporarily storing instructions 2095 or software executed by processing circuitry 2060. Each hardware device may comprise one or more network interface controllers (NICs) 2070, also known as network interface cards, which include physical network interface 2080. Each hardware device may also include non-transitory, persistent, machine-readable storage media 2090-2 having stored therein software 2095 and/or instructions executable by processing circuitry 2060. Software 2095 may include any type of software including software for instantiating one or more virtualization layers 2050 (also referred to as hypervisors), software to execute virtual machines 2040 as well as software allowing it to execute functions, features and/or benefits described in relation with some embodiments described herein.

Virtual machines 2040, comprise virtual processing, virtual memory, virtual networking or interface and virtual storage, and may be run by a corresponding virtualization layer 2050 or hypervisor. Different embodiments of the instance of virtual appliance 2020 may be implemented on one or more of virtual machines 2040, and the implementations may be made in different ways.

During operation, processing circuitry 2060 executes software 2095 to instantiate the hypervisor or virtualization layer 2050, which may sometimes be referred to as a virtual machine monitor (VMM). Virtualization layer 2050 may present a virtual operating platform that appears like networking hardware to virtual machine 2040.

As shown in FIG. 20, hardware 2030 may be a standalone network node with generic or specific components. Hardware 2030 may comprise antenna 20225 and may implement some functions via virtualization. Alternatively, hardware 2030 may be part of a larger cluster of hardware (e.g. such as in a data center or customer premise equipment (CPE)) where many hardware nodes work together and are managed via management and orchestration (MANO) 20100, which, among others, oversees lifecycle management of applications 2020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2040 may be a software implementation of a physical machine that runs programs as if they were executing on a physical, non-virtualized machine. Each of virtual machines 2040, and that part of hardware 2030 that executes that virtual machine, be it hardware dedicated to that virtual machine and/or hardware shared by that virtual machine with others of the virtual machines 2040, forms a separate virtual network elements (VNE).

Still in the context of NFV, Virtual Network Function (VNF) is responsible for handling specific network functions that run in one or more virtual machines 2040 on top of hardware networking infrastructure 2030 and corresponds to application 2020 in FIG. 20.

In some embodiments, one or more radio units 20200 that each include one or more transmitters 20220 and one or more receivers 20210 may be coupled to one or more antennas 20225. Radio units 20200 may communicate directly with hardware nodes 2030 via one or more appropriate network interfaces and may be used in combination with the virtual components to provide a virtual node with radio capabilities, such as a radio access node or a base station.

In some embodiments, some signalling can be effected with the use of control system 20230 which may alternatively be used for communication between the hardware nodes 2030 and radio units 20200.

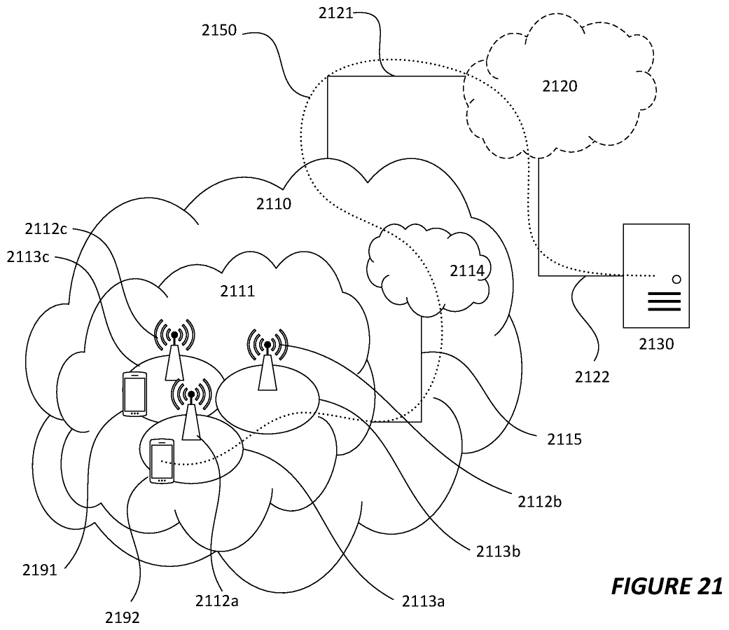

FIG. 21 illustrates a telecommunication network connected via an intermediate network to a host computer in accordance with some embodiments. In particular, with reference to FIG. 21, in accordance with an embodiment, a communication system includes telecommunication network 2110, such as a 3GPP-type cellular network, which comprises access network 2111, such as a radio access network, and core network 2114. Access network 2111 comprises a plurality of base stations 2112a, 2112b, 2112c, such as NBs, eNBs, gNBs or other types of wireless access points, each defining a corresponding coverage area 2113a, 2113b, 2113c. Each base station 2112a, 2112b, 2112c is connectable to core network 2114 over a wired or wireless connection 2115. A first UE 2191 located in coverage area 2113c is configured to wirelessly connect to, or be paged by, the corresponding base station 2112c. A second UE 2192 in coverage area 2113a is wirelessly connectable to the corresponding base station 2112a. While a plurality of UEs 2191, 2192 are illustrated in this example, the disclosed embodiments are equally applicable to a situation where a sole UE is in the coverage area or where a sole UE is connecting to the corresponding base station 2112.

Telecommunication network 2110 is itself connected to host computer 2130, which may be embodied in the hardware and/or software of a standalone server, a cloud-implemented server, a distributed server or as processing resources in a server farm. Host computer 2130 may be under the ownership or control of a service provider, or may be operated by the service provider or on behalf of the service provider. Connections 2121 and 2122 between telecommunication network 2110 and host computer 2130 may extend directly from core network 2114 to host computer 2130 or may go via an optional intermediate network 2120. Intermediate network 2120 may be one of, or a combination of more than one of, a public, private or hosted network; intermediate network 2120, if any, may be a backbone network or the Internet; in particular, intermediate network 2120 may comprise two or more sub-networks (not shown).

The communication system of FIG. 21 as a whole enables connectivity between the connected UEs 2191, 2192 and host computer 2130. The connectivity may be described as an over-the-top (OTT) connection 2150. Host computer 2130 and the connected UEs 2191, 2192 are configured to communicate data and/or signaling via OTT connection 2150, using access network 2111, core network 2114, any intermediate network 2120 and possible further infrastructure (not shown) as intermediaries. OTT connection 2150 may be transparent in the sense that the participating communication devices through which OTT connection 2150 passes are unaware of routing of uplink and downlink communications. For example, base station 2112 may not or need not be informed about the past routing of an incoming downlink communication with data originating from host computer 2130 to be forwarded (e.g., handed over) to a connected UE 2191. Similarly, base station 2112 need not be aware of the future routing of an outgoing uplink communication originating from the UE 2191 towards the host computer 2130.

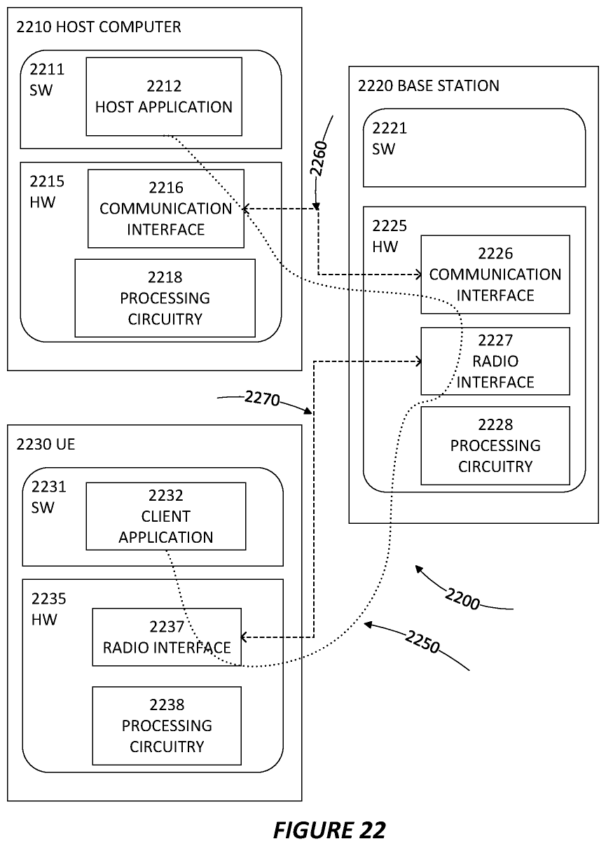

Example implementations, in accordance with an embodiment, of the UE, base station and host computer discussed in the preceding paragraphs will now be described with reference to FIG. 22. FIG. 22 illustrates host computer communicating via a base station with a user equipment over a partially wireless connection in accordance with some embodiments In communication system 2200, host computer 2210 comprises hardware 2215 including communication interface 2216 configured to set up and maintain a wired or wireless connection with an interface of a different communication device of communication system 2200. Host computer 2210 further comprises processing circuitry 2218, which may have storage and/or processing capabilities. In particular, processing circuitry 2218 may comprise one or more programmable processors, application-specific integrated circuits, field programmable gate arrays or combinations of these (not shown) adapted to execute instructions. Host computer 2210 further comprises software 2211, which is stored in or accessible by host computer 2210 and executable by processing circuitry 2218. Software 2211 includes host application 2212. Host application 2212 may be operable to provide a service to a remote user, such as UE 2230 connecting via OTT connection 2250 terminating at UE 2230 and host computer 2210. In providing the service to the remote user, host application 2212 may provide user data which is transmitted using OTT connection 2250.

Communication system 2200 further includes base station 2220 provided in a telecommunication system and comprising hardware 2225 enabling it to communicate with host computer 2210 and with UE 2230. Hardware 2225 may include communication interface 2226 for setting up and maintaining a wired or wireless connection with an interface of a different communication device of communication system 2200, as well as radio interface 2227 for setting up and maintaining at least wireless connection 2270 with UE 2230 located in a coverage area (not shown in FIG. 22) served by base station 2220. Communication interface 2226 may be configured to facilitate connection 2260 to host computer 2210. Connection 2260 may be direct or it may pass through a core network (not shown in FIG. 22) of the telecommunication system and/or through one or more intermediate networks outside the telecommunication system. In the embodiment shown, hardware 2225 of base station 2220 further includes processing circuitry 2228, which may comprise one or more programmable processors, application-specific integrated circuits, field programmable gate arrays or combinations of these (not shown) adapted to execute instructions. Base station 2220 further has software 2221 stored internally or accessible via an external connection.

Communication system 2200 further includes UE 2230 already referred to. Its hardware 2235 may include radio interface 2237 configured to set up and maintain wireless connection 2270 with a base station serving a coverage area in which UE 2230 is currently located. Hardware 2235 of UE 2230 further includes processing circuitry 2238, which may comprise one or more programmable processors, application-specific integrated circuits, field programmable gate arrays or combinations of these (not shown) adapted to execute instructions. UE 2230 further comprises software 2231, which is stored in or accessible by UE 2230 and executable by processing circuitry 2238. Software 2231 includes client application 2232. Client application 2232 may be operable to provide a service to a human or non-human user via UE 2230, with the support of host computer 2210. In host computer 2210, an executing host application 2212 may communicate with the executing client application 2232 via OTT connection 2250 terminating at UE 2230 and host computer 2210. In providing the service to the user, client application 2232 may receive request data from host application 2212 and provide user data in response to the request data. OTT connection 2250 may transfer both the request data and the user data. Client application 2232 may interact with the user to generate the user data that it provides.

It is noted that host computer 2210, base station 2220 and UE 2230 illustrated in FIG. 22 may be similar or identical to host computer 2130, one of base stations 2112a, 2112b, 2112c and one of UEs 2191, 2192 of FIG. 21, respectively. This is to say, the inner workings of these entities may be as shown in FIG. 22 and independently, the surrounding network topology may be that of FIG. 21.

In FIG. 22, OTT connection 2250 has been drawn abstractly to illustrate the communication between host computer 2210 and UE 2230 via base station 2220, without explicit reference to any intermediary devices and the precise routing of messages via these devices. Network infrastructure may determine the routing, which it may be configured to hide from UE 2230 or from the service provider operating host computer 2210, or both. While OTT connection 2250 is active, the network infrastructure may further take decisions by which it dynamically changes the routing (e.g., on the basis of load balancing consideration or reconfiguration of the network).

Wireless connection 2270 between UE 2230 and base station 2220 is in accordance with the teachings of the embodiments described throughout this disclosure. One or more of the various embodiments improve the performance of OTT services provided to UE 2230 using OTT connection 2250, in which wireless connection 2270 forms the last segment.

A measurement procedure may be provided for the purpose of monitoring data rate, latency and other factors on which the one or more embodiments improve. There may further be an optional network functionality for reconfiguring OTT connection 2250 between host computer 2210 and UE 2230, in response to variations in the measurement results. The measurement procedure and/or the network functionality for reconfiguring OTT connection 2250 may be implemented in software 2211 and hardware 2215 of host computer 2210 or in software 2231 and hardware 2235 of UE 2230, or both. In embodiments, sensors (not shown) may be deployed in or in association with communication devices through which OTT connection 2250 passes; the sensors may participate in the measurement procedure by supplying values of the monitored quantities exemplified above, or supplying values of other physical quantities from which software 2211, 2231 may compute or estimate the monitored quantities. The reconfiguring of OTT connection 2250 may include message format, retransmission settings, preferred routing etc.; the reconfiguring need not affect base station 2220, and it may be unknown or imperceptible to base station 2220. Such procedures and functionalities may be known and practiced in the art. In certain embodiments, measurements may involve proprietary UE signaling facilitating host computer 2210's measurements of throughput, propagation times, latency and the like. The measurements may be implemented in that software 2211 and 2231 causes messages to be transmitted, in particular empty or ‘dummy’ messages, using OTT connection 2250 while it monitors propagation times, errors etc.

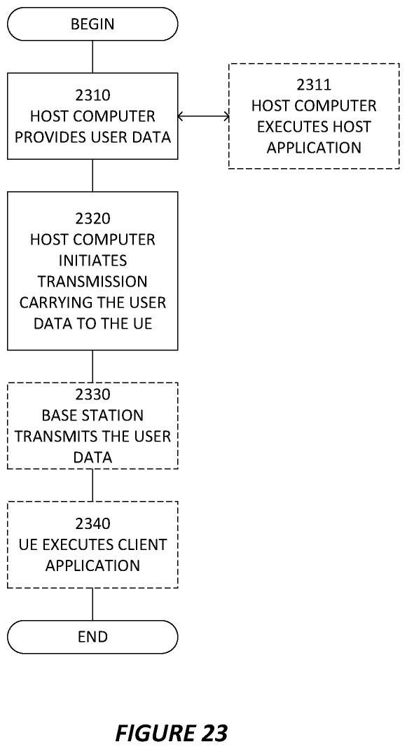

FIG. 23 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 23 will be included in this section. In step 2310, the host computer provides user data. In substep 2311 (which may be optional) of step 2310, the host computer provides the user data by executing a host application. In step 2320, the host computer initiates a transmission carrying the user data to the UE. In step 2330 (which may be optional), the base station transmits to the UE the user data which was carried in the transmission that the host computer initiated, in accordance with the teachings of the embodiments described throughout this disclosure. In step 2340 (which may also be optional), the UE executes a client application associated with the host application executed by the host computer.

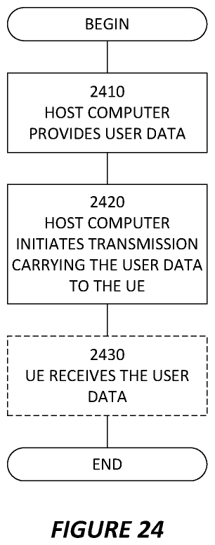

FIG. 24 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 24 will be included in this section. In step 2410 of the method, the host computer provides user data. In an optional substep (not shown) the host computer provides the user data by executing a host application. In step 2420, the host computer initiates a transmission carrying the user data to the UE. The transmission may pass via the base station, in accordance with the teachings of the embodiments described throughout this disclosure. In step 2430 (which may be optional), the UE receives the user data carried in the transmission.

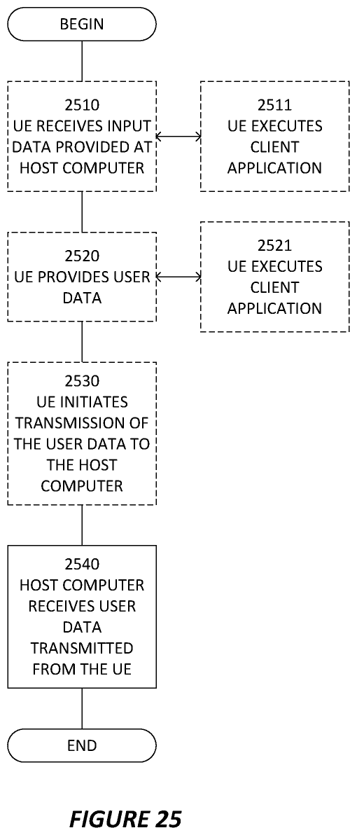

FIG. 25 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 25 will be included in this section. In step 2510 (which may be optional), the UE receives input data provided by the host computer. Additionally or alternatively, in step 2520, the UE provides user data. In substep 2521 (which may be optional) of step 2520, the UE provides the user data by executing a client application. In substep 2511 (which may be optional) of step 2510, the UE executes a client application which provides the user data in reaction to the received input data provided by the host computer. In providing the user data, the executed client application may further consider user input received from the user. Regardless of the specific manner in which the user data was provided, the UE initiates, in substep 2530 (which may be optional), transmission of the user data to the host computer. In step 2540 of the method, the host computer receives the user data transmitted from the UE, in accordance with the teachings of the embodiments described throughout this disclosure.

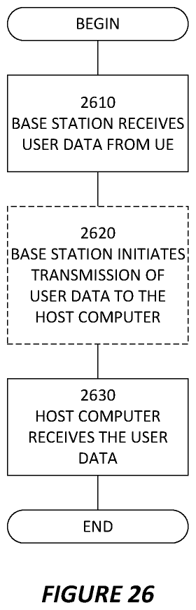

FIG. 26 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 26 will be included in this section. In step 2610 (which may be optional), in accordance with the teachings of the embodiments described throughout this disclosure, the base station receives user data from the UE. In step 2620 (which may be optional), the base station initiates transmission of the received user data to the host computer. In step 2630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a network node configured to operate as a source network node of a reconfiguration procedure, the method comprising:
transmitting, to a target network node of the reconfiguration procedure, signaling that indicates (i) whether or not the target network node is to provide feedback information to the source network node and/or (ii) which one or more types of feedback information the target network node is to provide to the source network node.
   A2. The method of embodiment A1, wherein the feedback information includes at least one of any one or more of:
information about the reconfiguration procedure;
information about a wireless device that performs the reconfiguration procedure;
information about the target network node or a target cell during or after the reconfiguration procedure;
one or more measurements performed by the target network node during and/or after the reconfiguration procedure; and
one or more measurements performed by the wireless device during and/or after the reconfiguration procedure.
   A3. The method of any of embodiments A1-A2, further comprising receiving an acknowledgement from the target network node indicating whether or not the target network node will provide the feedback information as indicated.
   A4. The method of any of embodiments A1-A3, further comprising receiving the feedback information indicated by the signaling.
   A5. The method of embodiment A4, further comprising:
training, based on the received feedback information, a model to predict predicted information;
predicting the predicted information using the model; and
making a decision based on the predicted information.
   A6. The method of embodiment A5, wherein the decision is a decision about:
whether a wireless device is to perform a reconfiguration procedure to the target network node;
which wireless device is to perform a reconfiguration procedure to the target network node; or
which network node is to be a target of a reconfiguration procedure to be performed by a wireless device.
   A7. The method of any of embodiments A1-A6, further comprising dynamically adapting, based on one or more feedback adaptation criteria, whether or not the target network node is to provide feedback information to the source network node and/or (ii) which one or more types of feedback information the target network node is to provide to the source network node.
   A8. The method of any of embodiments A1-A7, further comprising selecting the one or more types of feedback information based on one or more feedback type selection criteria.
   A9. The method of any of embodiments A1-A8, wherein the reconfiguration procedure is a mobility procedure.
   A10. The method of any of embodiments A1-A8, wherein the reconfiguration procedure is a PSCell addition or change procedure.
   A11. The method of any of embodiments A1-A10, wherein the reconfiguration procedure is a conditional reconfiguration procedure.
   AA. The method of any of the previous embodiments, further comprising:
obtaining user data; and
forwarding the user data to a host computer or a wireless device.

### Group B Embodiments

B1. A method performed by a network node configured to operate as a target network node of a reconfiguration procedure, the method comprising:
receiving, from a source network node of the reconfiguration procedure, signaling that indicates (i) whether or not the target network node is to provide feedback information to the source network node and/or (ii) which one or more types of feedback information the target network node is to provide to the source network node.
   B2. The method of embodiment B1, wherein the feedback information includes at least one of any one or more of:
information about the reconfiguration procedure;
information about a wireless device that performs the reconfiguration procedure;
information about the target network node or a target cell during or after the reconfiguration procedure;
one or more measurements performed by the target network node during and/or after the reconfiguration procedure; and
one or more measurements performed by the wireless device during and/or after the reconfiguration procedure.
   B3. The method of any of embodiments B1-B2, further comprising transmitting an acknowledgement to the source network node indicating whether or not the target network node will provide the feedback information as indicated.
   B4. The method of any of embodiments B1-B3, further comprising transmitting the feedback information indicated by the signaling.
   B5. The method of any of embodiments B1-B4, wherein the reconfiguration procedure is a mobility procedure.
   B6. The method of any of embodiments B1-B4, wherein the reconfiguration procedure is a PSCell addition or change procedure.
   B7. The method of any of embodiments B1-B6, wherein the reconfiguration procedure is a conditional reconfiguration procedure.
   BB. The method of any of the previous embodiments, further comprising:
obtaining user data; and
forwarding the user data to a host computer or a wireless device.

### Group C Embodiments

C1. A network node configured to perform any of the steps of any of the Group A or Group B embodiments.
C2. A network node comprising processing circuitry configured to perform any of the steps of any of the Group A or Group B embodiments.
C3. A network node comprising:
communication circuitry; and
processing circuitry configured to perform any of the steps of any of the Group A or Group B embodiments.
   C4. A network node comprising:
processing circuitry configured to perform any of the steps of any of the Group A or Group B embodiments; and
power supply circuitry configured to supply power to the network node.
   C5. A network node comprising:
processing circuitry and memory, the memory containing instructions executable by the processing circuitry whereby the network node is configured to perform any of the steps of any of the Group A or Group B embodiments.
   C7. A computer program comprising instructions which, when executed by at least one processor of a network node, causes the network node to carry out the steps of any of the Group A or Group B embodiments.
   C8. A carrier containing the computer program of embodiment C7, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group A or Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group A or Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.

### D9-D22. Reserved.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group A or Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
the processing circuitry of the host computer is configured to execute a host application;
the UE is configured to execute a client application associated with the host application, thereby providing the user data to be received by the host computer.

1.-33. (canceled)

34. A method performed by a network node configured to operate as a source network node of a reconfiguration procedure, the method comprising:
transmitting, to a target network node of the reconfiguration procedure, signaling that indicates (i) whether or not the target network node is to provide feedback information to the source network node and/or (ii) which one or more types of feedback information the target network node is to provide to the source network node.

35. The method of claim 34, wherein the feedback information includes at least one of any one or more of the following types of feedback information:
information about the reconfiguration procedure;
information about a wireless device that performs the reconfiguration procedure;
information about the target network node or a target cell during or after the reconfiguration procedure;
one or more measurements performed by the target network node during and/or after the reconfiguration procedure; and
one or more measurements performed by the wireless device during and/or after the reconfiguration procedure.

36. The method of claim 34, wherein the feedback information includes:
information about a configuration adopted for a wireless device after the wireless device performs the reconfiguration procedure; and/or
information about a configuration at the target network node during and/or after the reconfiguration procedure.

37. The method of claim 36:
wherein the information about the configuration adopted for the wireless device includes information about at least one of any one or more of:
a dual connectivity configuration adopted for the wireless device after the wireless device performs the reconfiguration procedure;
a carrier aggregation configuration adopted for the wireless device after the wireless device performs the reconfiguration procedure; and
a feature set and/or band combination adopted for the wireless device after the wireless device performs the reconfiguration procedure; and/or
wherein the information about the configuration at the target network node during and/or after the reconfiguration procedure includes information about at least one of any one or more of:
overall capacity utilized by a wireless device at the target network node;
overall percentage of physical resource blocks used by a wireless device at a target cell of the reconfiguration procedure; and
overall throughput achieved via a configuration applied at a wireless device after the wireless device performs the reconfiguration procedure.

38. The method of claim 34, wherein the signaling indicates:
a time window within which the feedback information is requested from the target network node after execution of the reconfiguration procedure; and/or
a criterion that is to trigger the target network node to transmit a type of feedback information to the source network node, wherein the criterion is that a value of the type of feedback information is below a threshold, is above a threshold, is outside of a range, or is inside of a range, wherein the signaling indicates the threshold or the range.

39. The method of claim 34, further comprising:
receiving the feedback information indicated by the signaling;
training, based on the received feedback information, a model to predict predicted information;
predicting the predicted information using the model; and
making a decision based on the predicted information, wherein the decision is a decision about:
whether a wireless device is to perform a reconfiguration procedure to the target network node;
which wireless device is to perform a reconfiguration procedure to the target network node; or
which network node is to be a target of a reconfiguration procedure to be performed by a wireless device.

40. A method performed by a network node configured to operate as a target network node of a reconfiguration procedure, the method comprising:
receiving, from a source network node of the reconfiguration procedure, signaling that indicates (i) whether or not the target network node is to provide feedback information to the source network node and/or (ii) which one or more types of feedback information the target network node is to provide to the source network node.

41. The method of claim 40, wherein the feedback information includes at least one of any one or more of the following types of feedback information:
information about the reconfiguration procedure;
information about a wireless device that performs the reconfiguration procedure;
information about the target network node or a target cell during or after the reconfiguration procedure;
one or more measurements performed by the target network node during and/or after the reconfiguration procedure; and
one or more measurements performed by the wireless device during and/or after the reconfiguration procedure.

42. The method of claim 40, wherein the feedback information includes:
information about a configuration adopted for a wireless device after the wireless device performs the reconfiguration procedure; and/or
information about a configuration at the target network node during and/or after the reconfiguration procedure.

43. The method of claim 42:
wherein the information about the configuration at the target network node during and/or after the reconfiguration procedure includes information about at least one of any one or more of:
overall capacity utilized by a wireless device at the target network node;
overall percentage of physical resource blocks used by a wireless device at a target cell of the reconfiguration procedure; and
overall throughput achieved via a configuration applied at a wireless device after the wireless device performs the reconfiguration procedure; and/or
wherein the information about the configuration adopted for the wireless device includes information about at least one of any one or more of:
a dual connectivity configuration adopted for the wireless device after the wireless device performs the reconfiguration procedure;
a carrier aggregation configuration adopted for the wireless device after the wireless device performs the reconfiguration procedure; and
a feature set and/or band combination adopted for the wireless device after the wireless device performs the reconfiguration procedure.

44. The method of claim 40, wherein the signaling indicates:
a time window within which the feedback information is requested from the target network node after execution of the reconfiguration procedure; and/or
a criterion that is to trigger the target network node to transmit a type of feedback information to the source network node, wherein the criterion is that a value of the type of feedback information is below a threshold, is above a threshold, is outside of a range, or is inside of a range, wherein the signaling indicates the threshold or the range.

45. The method of claim 40, further comprising:
deciding, based on the received signaling, whether to transmit feedback information to the source network node and/or which one or more types of feedback information to transmit to the source network node; and/or
transmitting, to the source network node, the feedback information indicated by the signaling.

46. A network node configured to operate as a source network node of a reconfiguration procedure, the network node comprising:
communication circuitry; and
processing circuitry configured to transmit, to a target network node of the reconfiguration procedure, signaling that indicates (i) whether or not the target network node is to provide feedback information to the source network node and/or (ii) which one or more types of feedback information the target network node is to provide to the source network node.

47. The network node of claim 46, wherein the feedback information includes at least one of any one or more of the following types of feedback information:
information about the reconfiguration procedure;
information about a wireless device that performs the reconfiguration procedure;
information about the target network node or a target cell during or after the reconfiguration procedure;
one or more measurements performed by the target network node during and/or after the reconfiguration procedure; and
one or more measurements performed by the wireless device during and/or after the reconfiguration procedure.

48. The network node of claim 46, wherein the feedback information includes:
information about a configuration adopted for a wireless device after the wireless device performs the reconfiguration procedure; and/or
information about a configuration at the target network node during and/or after the reconfiguration procedure.

49. The network node of claim 48,
wherein the information about the configuration adopted for the wireless device includes information about at least one of any one or more of:
a dual connectivity configuration adopted for the wireless device after the wireless device performs the reconfiguration procedure;
a carrier aggregation configuration adopted for the wireless device after the wireless device performs the reconfiguration procedure; and
a feature set and/or band combination adopted for the wireless device after the wireless device performs the reconfiguration procedure; and/or
wherein the information about the configuration at the target network node during and/or after the reconfiguration procedure includes information about at least one of any one or more of:
overall capacity utilized by a wireless device at the target network node;
overall percentage of physical resource blocks used by a wireless device at a target cell of the reconfiguration procedure; and
overall throughput achieved via a configuration applied at a wireless device after the wireless device performs the reconfiguration procedure.

50. The network node of claim 46, wherein the signaling indicates:
a time window within which the feedback information is requested from the target network node after execution of the reconfiguration procedure; and/or
a criterion that is to trigger the target network node to transmit a type of feedback information to the source network node, wherein the criterion is that a value of the type of feedback information is below a threshold, is above a threshold, is outside of a range, or is inside of a range, wherein the signaling indicates the threshold or the range.

51. The network node of claim 46, wherein the processing circuitry is further configured to:
receive the feedback information indicated by the signaling;
train, based on the received feedback information, a model to predict predicted information;
predict the predicted information using the model; and
make a decision based on the predicted information, wherein the decision is a decision about:
whether a wireless device is to perform a reconfiguration procedure to the target network node;
which wireless device is to perform a reconfiguration procedure to the target network node; or
which network node is to be a target of a reconfiguration procedure to be performed by a wireless device.

52. A network node configured to operate as a target network node of a reconfiguration procedure, the network node comprising:
communication circuitry; and
processing circuitry configured to receive, from a source network node of the reconfiguration procedure, signaling that indicates (i) whether or not the target network node is to provide feedback information to the source network node and/or (ii) which one or more types of feedback information the target network node is to provide to the source network node.

53. The network node of claim 52, wherein the feedback information includes at least one of any one or more of the following types of feedback information:
information about the reconfiguration procedure;
information about a wireless device that performs the reconfiguration procedure;
information about the target network node or a target cell during or after the reconfiguration procedure;
one or more measurements performed by the target network node during and/or after the reconfiguration procedure; and
one or more measurements performed by the wireless device during and/or after the reconfiguration procedure.
